(19) United States
(12) Patent Application Publication
(10) Pub. No.: US 2011/0148754 A1
(43) Pub. Date: Jun. 23, 2011

(54) PROJECTION APPARATUS, DISPLAY APPARATUS, INFORMATION PROCESSING APPARATUS, PROJECTION SYSTEM AND DISPLAY SYSTEM

(75) Inventors: Kensuke Inagaki, Yokohama-shi (JP); Akihiro Tanabe, Tokyo (JP); Kazuhiro Monden, Inagi-shi (JP)

(73) Assignee: CANON KABUSHIKI KAISHA, Tokyo (JP)

(21) Appl. No.: 12/958,776

(22) Filed: Dec. 2, 2010

(30) Foreign Application Priority Data
Dec. 22, 2009 (JP) 2009-291400

(51) Int. Cl. H04N 5/74; G09G 5/00

(52) U.S. Cl. 345/156; 348/744; 348/E05.137

(57) ABSTRACT

A communication terminal is allowed to make data communication by simple processing. A communication unit is allowed to make data communication with a communication terminal when the detected position of the communication terminal remains unchanged for a predetermined time period or longer, within a range in which an image is projected.

### BACKGROUND OF THE INVENTION

1. Field of the Invention

The present invention relates to a projection apparatus, a display apparatus, information processing apparatus, projection system and display system.

2. Description of the Related Art

Conventionally, as a display apparatus which projects a presentation reference onto a large screen in a meeting room, a display or projector, for example, is known. For example, a projector of a type which projects an image onto a desk surface is used as a communication tool that allows all participants of a meeting to view the projection screen so as to share information and discuss. The same applies to the display.

Japanese Patent Laid-Open No. 2008-123476 (corresponding US 2008/0291283) describes an image processing apparatus 100, in which when a mobile information terminal 200 is placed on a touch panel 104, it is recognized by a wireless communication response 701 (see FIG. 10 of Japanese Patent Laid-Open No. 2008-123476(corresponding US 2008/0291283)). More specifically, when a controller unit 201 in the image processing apparatus 100 detects an input signal generated when an object is placed on the touch panel 104, it controls a wireless communication unit 206 to broadcast an inquiry IQ packet (see FIG. 7 of Japanese Patent Laid-Open No. 2008-123476 (corresponding US 2008/0291283)). The controller unit 201 controls the wireless communication unit 206 to detect whether or not it receives a communication response from the object placed on the touch panel 104. If a communication response is received, the controller unit 201 determines that the object placed on the touch panel 104 is the mobile information terminal 200, and transits the process to a communication mode. On the other hand, if no communication response is received, the controller unit 201 determines that the object placed on the touch panel 104 is a user's finger, and transits the process to an operation mode. With this control according to Japanese Patent Laid-Open No. 2008-123476 (corresponding US 2008/0291283), an appropriate display can be made depending on whether an object that contacts the touch panel 104 is a mobile information terminal or user's finger.

However, with the technique described in Japanese Patent Laid-Open No. 2008-123476 (corresponding US 2008/0291283), after the controller unit 201 transits the process to the communication mode, it forms a piconet (a network based on a point-to-point connection) with the mobile information terminal 200. That is, with the technique described in Japanese Patent Laid-Open No. 2008-123476 (corresponding US 2008/0291283), the controller unit 201 is required to control the wireless communication unit 206 to broadcast an inquiry IQ packet, so as to allow the mobile information terminal 200 to communicate with the image processing apparatus 100. Also, the controller unit 201 is required to control the wireless communication unit 206 to keep detecting whether or not it receives the same IQ packet as that which was broadcast during a predetermined period. For this reason, the overall processing required to allow the mobile information terminal 200 to communicate with the image processing apparatus 100 is complicated.

It is further demanded that information is displayed, which is associated with a wireless terminal within the projection screen on which an image is displayed by the aforementioned projector of the type that projects an image onto the desk surface, or the screen displayed on the display. At this time, assume that a PC (Personal Computer) that supplies the image data to be projected is connected to the projector. In this case, in order to meet the above demand, complicated authentication processing is required to allow communication between the PC and wireless terminal.

The present invention allows a wireless terminal to make the aforementioned communication by simple processing.

### SUMMARY OF THE INVENTION

A projection apparatus for projecting an image on a display surface according to one aspect of the present invention is characterized by comprising: a projection unit adapted to project an image on the display surface; a communication unit adapted to communicate with a communication terminal; a detector adapted to detect a position of the communication terminal; and a controller adapted to allow the communication unit to make data communication with the communication terminal, in response to the position of the communication terminal detected by the detector remaining unchanged for not less than a predetermined time period within a range in which the image is projected by the projection unit.

According to the present invention, the wireless terminal is allowed to communicate by simple processing.

Further features and advantages of the present invention will become apparent from the following description of the preferred embodiments with reference to the attached drawings.

### BRIEF DESCRIPTION OF THE DRAWINGS

FIG. 1 is a schematic view showing the arrangement of a display system according to the first embodiment;

FIG. 2 is a block diagram showing the arrangement of a display apparatus according to the first embodiment;

FIG. 3 is a block diagram showing the arrangement of an information processing apparatus according to the first embodiment;

FIG. 4 is a view showing a calculation method of a distance to a projection screen;

FIG. 5 is a flowchart of processing for authenticating a wireless terminal;

FIG. 6 is a view showing a state in which the wireless terminal is placed on the projection screen of the display apparatus;

FIG. 7 is a schematic view showing the arrangement of a display system according to the second embodiment;

FIG. 8 is a block diagram showing the arrangement of a display apparatus according to the second embodiment;

FIG. 9 is a block diagram showing the arrangement of an information processing apparatus according to the second embodiment;

FIG. 10 is a flowchart showing processing for calculating the size of a projection screen of the display apparatus;

FIG. 11 is a flowchart of processing for authenticating a wireless terminal;

FIG. 12 is a block diagram showing the arrangement of a display apparatus according to the third embodiment;

FIG. 13 is a flowchart showing the sequence of processing executed when a wireless terminal is placed on a control area;

FIG. 14 is a view showing display objects and their control areas;

FIG. 15 is a view showing display objects and their control areas;

FIG. 16 is a table showing operation examples when the wireless terminal is placed on corresponding control areas;

FIG. 17 is a table showing operation examples when the wireless terminal is placed on corresponding control areas;

FIG. 18 is a block diagram showing the arrangement of an information processing apparatus according to the fourth embodiment;

FIG. 19 is a block diagram showing the arrangement of a display apparatus according to the fifth embodiment;

FIG. 20 is a flowchart showing the sequence of processing menu display processing;

FIG. 21 is a table showing an example of a communication allowed terminal list;

FIG. 22 is a table showing an example of a pattern list;

FIG. 23 is a view showing first and second display objects;

FIG. 24 is a view showing first and second display objects;

FIG. 25 is a block diagram showing the arrangement of an information processing apparatus according to the sixth embodiment;

FIG. 26 is a schematic view showing the arrangement of a display system according to a modification; and

FIG. 27 is a block diagram showing the arrangement of a display apparatus according to the modification.

### DESCRIPTION OF THE EMBODIMENTS

The embodiments will be described with reference to the drawings.

### First Embodiment

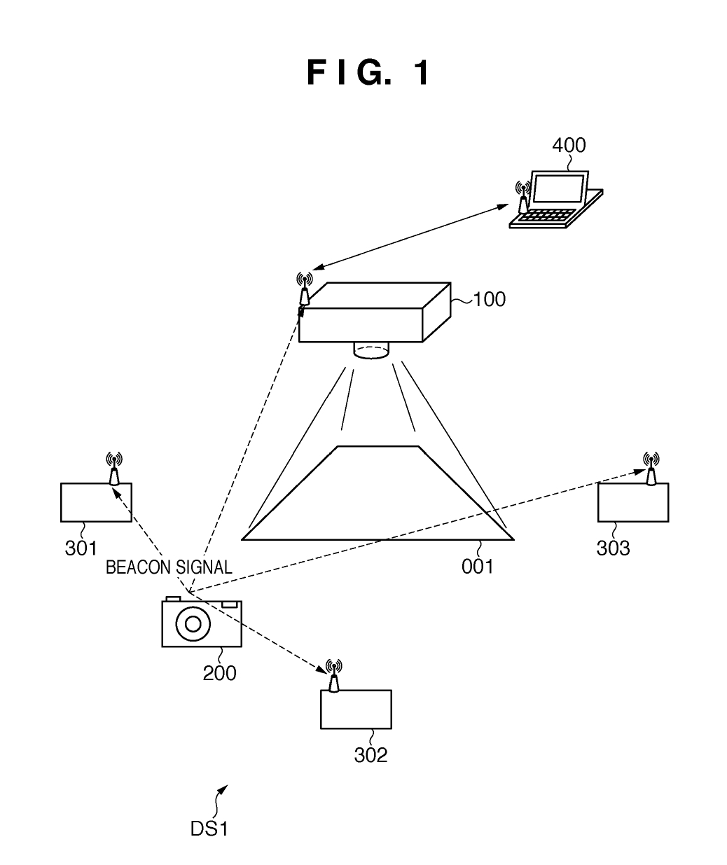

A schematic arrangement of a display system DS1 according to the first embodiment of the present invention will be described below with reference to FIG. 1.

The display system DS1 includes a wireless terminal 200, display apparatus 100, information processing apparatus 400, and a minimum of three communication devices 301 to 303.

The wireless terminal 200 can make communications for exchanging data with the display apparatus 100 and information processing apparatus 400. The wireless terminal 200 can communicate with the display apparatus 100 when communication with the display apparatus 100 via a wireless LAN is allowed. The wireless terminal 200 includes, for example, a digital camera, a video camera, a mobile information terminal such as a PDA, a mobile communication terminal such as a mobile phone, a compact printer, or a game machine. Alternatively, the wireless terminal 200 may be another apparatus which exchanges, for example, audio, image, and control data.

The display apparatus 100 forms a projection screen (display screen) 001 by projecting light modulated according to image data, and displays an image according to the image data on the projection screen 001. The display apparatus 100 includes, for example, a projector. Image data is stored in, for example, a storage unit (storage) of the display apparatus main body. Alternatively, the display apparatus 100 receives image data from the information processing apparatus 400 via a wireless LAN, and stores it in its storage.

The information processing apparatus 400 is, for example, a personal computer, and transmits image data of an image to be displayed to the display apparatus 100 via a wireless LAN. In this case, image data may be transmitted via a VGA cable or USB cable. That is, communication means is not particularly limited as long as it can transfer image data.

The communication devices 301 to 303 are arranged around the projection screen (display screen) 001. The communication devices 301 to 303 are allowed to communicate with the display apparatus 100. The communication devices 301 to 303 include, for example, access points in a wireless LAN. The display apparatus 100 can communicate with the communication devices 301 to 303 via the wireless LAN.

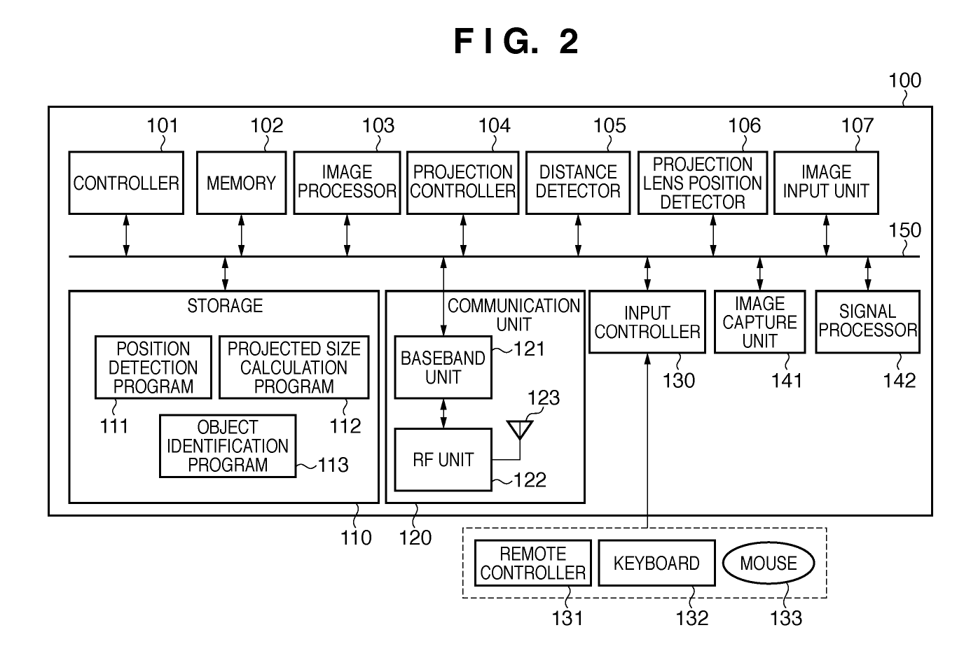

The arrangement of the display apparatus 100 will be described below with reference to FIG. 2.

The display apparatus 100 includes a controller 101, memory 102, storage 110, image processor 103, projection controller (display means) 104, distance detector 105, projection lens position detector 106, image input unit 107, communication unit 120, and input controller 130. Also, the display apparatus 100 includes an image capture unit 141 and signal processor 142.

The controller 101 controls the respective units in the display apparatus 100 via a control bus 150 in cooperation with the memory 102 which includes an SRAM and DRAM. The memory 102 temporarily stores data and programs. The memory 102 serves as a work area or buffer area of the controller 101.

The storage 110 stores data and programs which are not erased even after power-OFF. The storage 110 also stores image data to be displayed on the projection screen 001. The storage 110 stores a position detection program 111, projected size calculation program 112, and object identification program 113. The position detection program 111 is used to detect the position of a wireless terminal which includes a communication function via a wireless LAN. The projected size calculation program 112 is used to calculate the size of the projection screen which is being projected by the projection controller 104. The object identification program 113 is used to discriminate whether or not the wireless terminal contacts the projection screen 001. Note that the storage 110 also stores an operation system, projection control program, image control program, and wireless LAN control program. The controller 101 controls the image processor 103 to adjust the colors, luminance values, and the like of pixels in image data. The image processor 103 supplies adjusted image data to the projection controller 104.

The controller 101 further controls the projection controller 104 to attain, for example, lens driving control and lamp ON/OFF control. Then, the projection controller 104 displays an image on the display screen. That is, the projection controller 104 forms the projection screen (display screen) 001 by projecting light modulated according to image data, and displays an image according to the image data on the projection screen 001.

The projection controller 104 controls the distance detector 105 which includes, for example, an infrared sensor, to detect a distance from the display apparatus 100 to the projection screen 001. The projection controller 104 can acquire position information of a lens which is periodically sent from the projection lens position detector 106.

The image input unit 107 is an interface used to receive image data, which is received from an external apparatus such as the information processing apparatus 400 via, for example, a connected VGA cable. The image input unit 107 supplies the received image data to the image processor 103.

The controller 101 controls the communication unit 120 to be able to exchange packets compliant with the wireless LAN standard. That is, the communication unit 120 makes a communication. The communication unit 120 includes an antenna 123, baseband unit 121, and RF unit 122. A radio signal sent from a base station (not shown) is received by the antenna 123, and the received signal is input to the RF unit 122. The RF unit 122 includes, for example, a high-frequency amplifier, frequency converter, and demodulator. The RF unit 122 low-noise amplifies the signal input from the antenna 123 using a low-noise amplifier. The baseband unit 121 frequency-converts the amplified signal into a reception baseband signal. The RF unit 122 demodulates the converted signal.

The input controller 130 receives input signals from input devices such as a remote controller 131, keyboard 132, and mouse 133, and supplies them to the controller 101. The controller 101 executes appropriate processing according to the input signals.

The image capture unit 141 captures an image of an object to generate an image signal, and supplies the image signal to the signal processor 142. The signal processor 142 processes the received image signal to generate image data. Furthermore, the signal processor 142 reads out or writes image data from or in the storage 110. For example, the signal processor 142 generates compressed image data by encoding image data by a known encoding method in a recording mode, and transmits the compressed image data to the storage 110. Also, the signal processor 142 reads out image data by decoding compressed image data by a known encoding method in a reproduction mode. The signal processor 142 supplies the readout image data to the projection controller 104.

The controller 101 further has the following functions: a function of detecting the position of the wireless terminal 200; a function of discriminating based on the detected position of the wireless terminal 200 whether or not the wireless terminal 200 contacts the display surface 001; and a function of allowing, when it is discriminated that the wireless terminal 200 contacts the display surface 001, the communication unit 120 to communicate with the wireless terminal 200, as will be described later.

With these functions, the wireless terminal 200 can be allowed to make a communication without registering information of its own in advance. Also, the wireless terminal 200 can be allowed to make a communication without broadcasting an inquiry IQ packet or without detecting whether or not it receives the same IQ packet as that which was broadcast during a predetermined period. That is, the wireless terminal 200 can be allowed to make a communication by simple processing.

The controller 101 discriminates whether or not at least one of the position and size of the projection screen 001 has been changed (second discrimination). When it is determined that at least one of the position and size of the projection screen 001 has been changed, the controller 101 changes the information of the display screen to be used in discrimination so as to match the changed projection screen 001.

In this way, the controller 101 can discriminate using the information of the display screen that fits the actual projection screen 001 whether or not the wireless terminal 200 contacts the display screen 001. As a result, the precision upon discriminating whether or not the wireless terminal 200 contacts the display screen 001 can be improved.

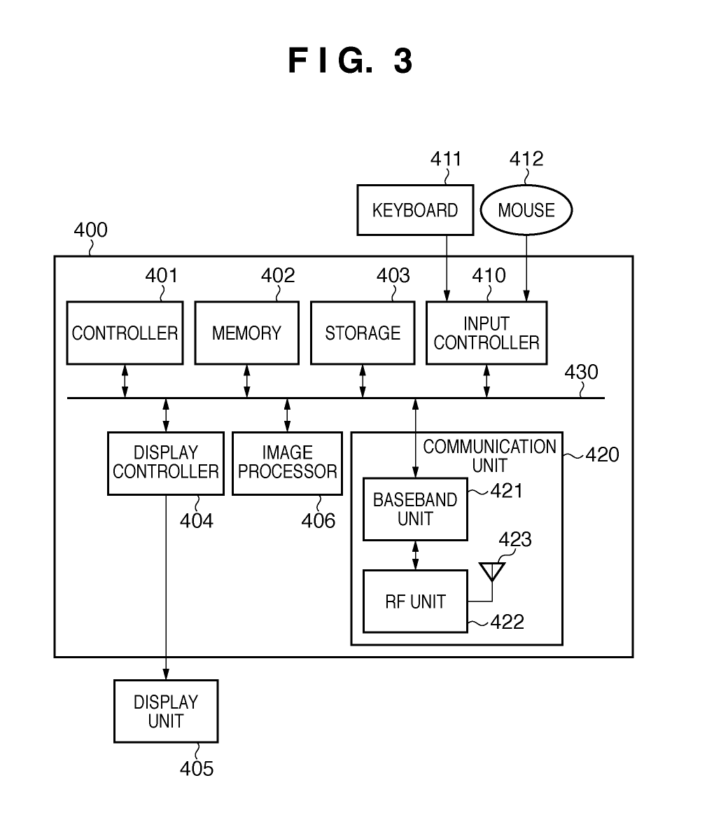

The arrangement of the information processing apparatus 400 will be described below with reference to FIG. 3.

A controller 401 controls respective units of the information processing apparatus 400 via a control bus 430 in cooperation with a memory 402.

The memory 402 temporarily stores data and programs. The memory 402 serves as a work area or buffer area of the controller 401. A storage 403 stores data and programs which are not erased even after power-OFF.

An input controller 410 receives input signals from input devices such as a keyboard 411 and mouse 412, and supplies them to the controller 401. The controller 401 executes appropriate processing according to the input signals.

The controller 401 controls an image processor 406 to adjust, for example, the colors and luminance values of respective pixels in image data. The image processor 406 supplies the adjusted image data to a display controller 404.

The controller 401 further controls the display controller 404 to display image data on a display unit 405 such as a display via a VGA cable or DVI cable.

The controller 401 controls a communication unit 420 to be able to exchange packets compliant with the wireless LAN standard. That is, the communication unit 420 makes a communication. In this connection, the information processing apparatus 400 of this embodiment can transmit image data from this communication unit 420 to the communication unit 120 of the display apparatus 100. The communication unit 420 includes an antenna 423, baseband unit 421, and RF unit 422. A radio signal sent from a base station (not shown) is received by the antenna 423, and the received signal is input to the RF unit 422. The RF unit 422 includes a high-frequency amplifier, frequency converter, and demodulator. The RF unit 422 low-noise amplifies the signal input from the antenna 423 using a low-noise amplifier. The baseband unit 421 frequency-converts the amplified signal into a reception baseband signal. The RF unit 422 demodulates the converted signal.

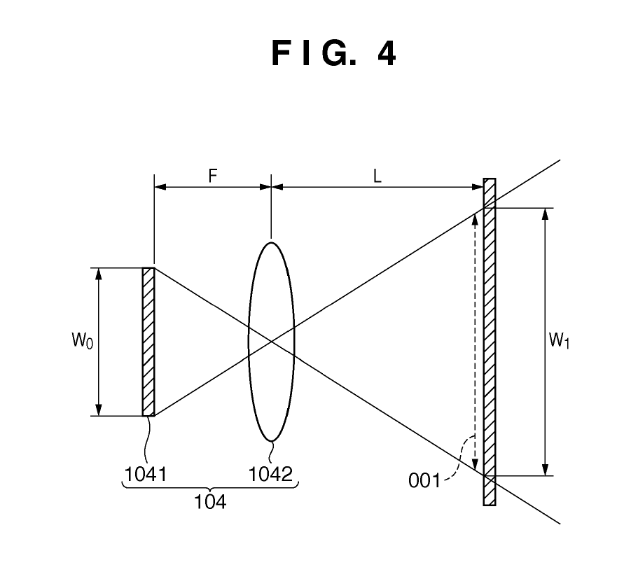

The projection screen size calculation method by the controller 101 according to the projected size calculation program 112 (see FIG. 2) will be described below with reference to FIG. 4.

Let W₀ be the size (for example, a width in the longitudinal direction) of a liquid crystal screen 1041, and F be the distance from the liquid crystal screen 1041 to a projection lens 1042. Also, let L be the distance from the projection lens 1042 to the projection screen 001, and W₁ be the size (for example, a width in the longitudinal direction) to be calculated of the projection screen 001. In this case, the projection lens position detector 106 detects the distance F from the liquid crystal screen 1041 to the projection lens 1042, and the distance detector 105 detects the distance L from the projection lens 1042 to the projection screen 001, as described above. Since W₁ to be calculated can be expressed by:

W₁=W₀×(L/F) (1)

W₁ can be calculated. Note that the liquid crystal screen 1041 and projection lens 1042 are included in the projection controller 104. A predetermined table which associates the output results of a line sensor used in focus adjustment of the display apparatus and the lens positions may be prepared in advance, and the distance may be calculated by means of table conversion.

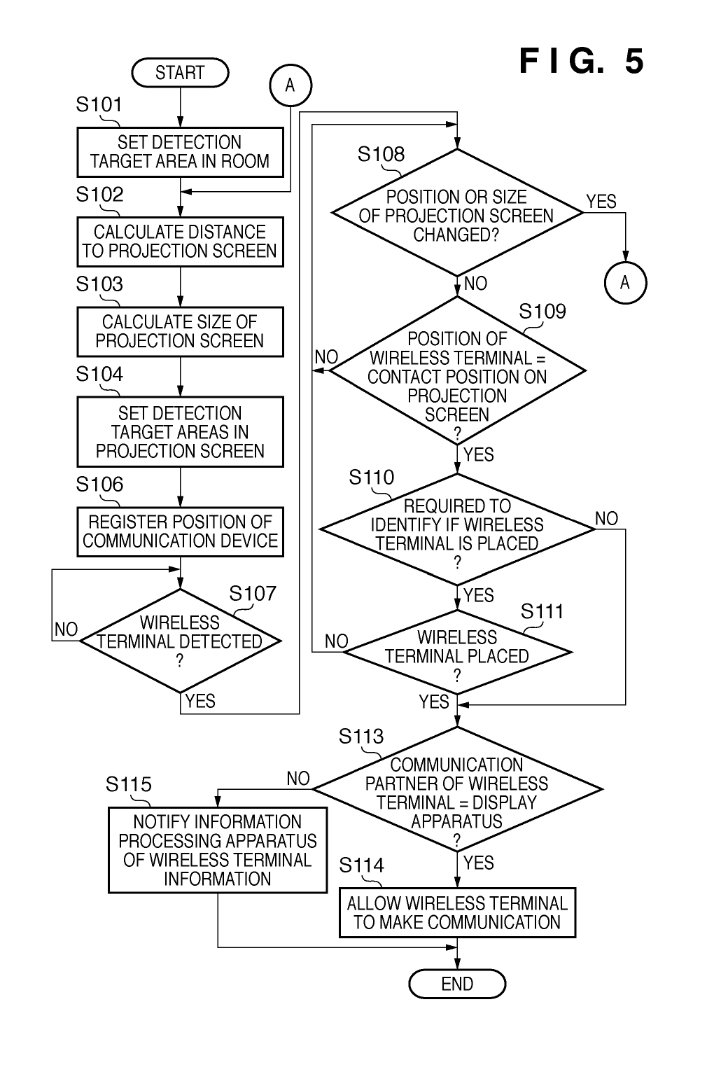

The sequence of processing executed from when the wireless terminal 200 is placed on the projection screen of the display apparatus 100 until it is authenticated will be described below with reference to FIG. 5.

The controller 101 of the display apparatus 100 sets, for example, the position of the projection screen of the display apparatus 100 in a room as a rough detection area (target detection area of the position of the wireless terminal) to have, as a base point, an installation location of the display apparatus 100 (S101). This is to designate a range of the room that can be used as the detection area when the position and size of the projection screen have been changed from those of the initially projected projection screen due to movement of the main body of the display apparatus 100 or shifting or enlarging of the lens. The range is designated on a predetermined operation screen by receiving inputs from the input devices such as the remote controller 131, keyboard 132, and mouse 133 by the input controller 130.

Next, the distance detector 105 calculates the distance to the projection screen (S102), as described above using FIG. 4. The controller 101 calculates the size of the projection screen from information of the projection lens position acquired from the projection lens position detector 106 using the projected size calculation program 112 (S103).

The controller 101 sets detailed detection areas (detection target areas of the position of the wireless terminal) within the calculated projection screen range (S104). This setting processing is also executed on a predetermined operation screen by receiving inputs from the input devices such as the remote controller 131, keyboard 132, and mouse 133 by the input controller 130 as in step 5101.

The controller 101 registers the positions of the communication devices 301 to 303 using the input devices such as the remote controller 131, keyboard 132, and mouse 133 so as to detect the position of the wireless terminal. The communication devices 301 to 303 are arranged around the display screen 001 (see FIG. 1). The pieces of registered position information of the communication devices 301 to 303 are stored in the memory 102 (S106).

Since it is ready to detect the position with the aforementioned steps, the controller 101 begins to detect the position of the wireless terminal (S107). In a state in which a communication between the display apparatus 100 and wireless terminal 200 is not allowed, the wireless terminal 200 periodically transmits a beacon signal (identification signal) of a MAC frame defined by the wireless LAN 802.11 standard. Note that the beacon signal includes information of a list of wireless transmission rates, a wireless channel number, and beacon period. When this signal is received, it can be judged that the wireless terminal exists. In step S107, the controller 101 waits until it receives this beacon signal (NO in step S107). If the controller 101 receives the beacon signal and discovers the wireless terminal 200 (YES in step S107), the process advances to step S108. Note that the communication devices 301 to 303 also receive the beacon signal (identification signal) from the wireless terminal 200 as in the display apparatus 100.

More specifically, the communication unit 120 receives the beacon signal from the wireless terminal 200, and also from the wireless terminal 200 via the minimum of three communication devices 301 to 303 arranged around the projection screen 001. The controller 101 detects the position of the wireless terminal 200 according to the beacon signal from the wireless terminal 200 received by the communication unit 120 and that from the wireless terminal 200 received by the communication unit 120 via the minimum of three communication devices 301 to 303.

More specifically, the controller 101 in the display apparatus 100 detects the position of the wireless terminal 200 by the following processing via the communication unit 120.

The controller 101 transmits, to all devices including the communication devices, a beacon signal including a time stamp as a sync signal required for time synchronization. The communication devices 301 to 303 which received the signal set their clocks based on the received time stamp. Next, the controller 101 records reception times of the beacon signal from the wireless terminal 200 by the communication devices 301 to 303 and the display apparatus 100.

Let P1, P2, . . . , Pn be the coordinates of the communication devices and those of the display apparatus 100, respectively, and t1, t2, . . . , tn be the reception times from the wireless terminal 200 by the respective communication devices. At this time, the controller 101 calculates a position P of the wireless terminal as coordinates which minimize a square error E(p, δ) which is expressed by equations (2) and (3) below. E(p, δ) is a sum for i=1 to n as per:

E(p,δ)=Σεi (2)

for εi which is given by:

εi=Wi{c(ti−tb+δ)−|p−pi|}2 (3)

where C is the radio propagation velocity, Wi is a non-negative weighting coefficient, tb is one of t1, t2, . . . , tn appropriate as a reference, δ is a reference clock error, and |X| is the magnitude of a vector X.

As described above, the controller 101 calculates the position of the wireless terminal 200 based on differences between the arrival times of signals returned to the communication devices 301 to 303 and the display apparatus 100 using the position detection program 111.

Note that the position may be detected by an RSSI (received signal strength indicator) method which detects the position from field strength differences in addition to the aforementioned TDOA (time difference of arrival) method.

Next, the controller 101 discriminates whether or not at least one of the position and size of the projection screen 001 has been changed due to movement of the main body of the display apparatus 100 or shifting or enlarging of the lens (S108). If the change has occurred (YES in step S108; A), the controller 101 returns the process to step S102, and re-sets the target area; if no change occurs (NO in step S108), the process advances to step S109. Note that the process in step S108 is executed after step S107 for the sake of descriptive simplicity. However, in practice, it is desirable to execute the process in step S108 after every step or as an independent process.

The controller 101 discriminates whether or not the detected wireless terminal 200 contacts the display screen 001. More specifically, the controller 101 discriminates whether or not the wireless terminal 200 is located within the detection area set in step S104 (S109). In this embodiment, whether or not the wireless terminal contacts the display screen is discriminated. Alternatively, whether or not the wireless terminal is inserted in an approximate projected range may be simply discriminated.

If the wireless terminal 200 is not located within the detection area of the projection screen 001 (NO in step S109), the controller 101 returns the process to step S108 to check a change in projection screen. If the wireless terminal 200 is located within the detection area (YES in step S109), the controller 101 advances the process to step S110.

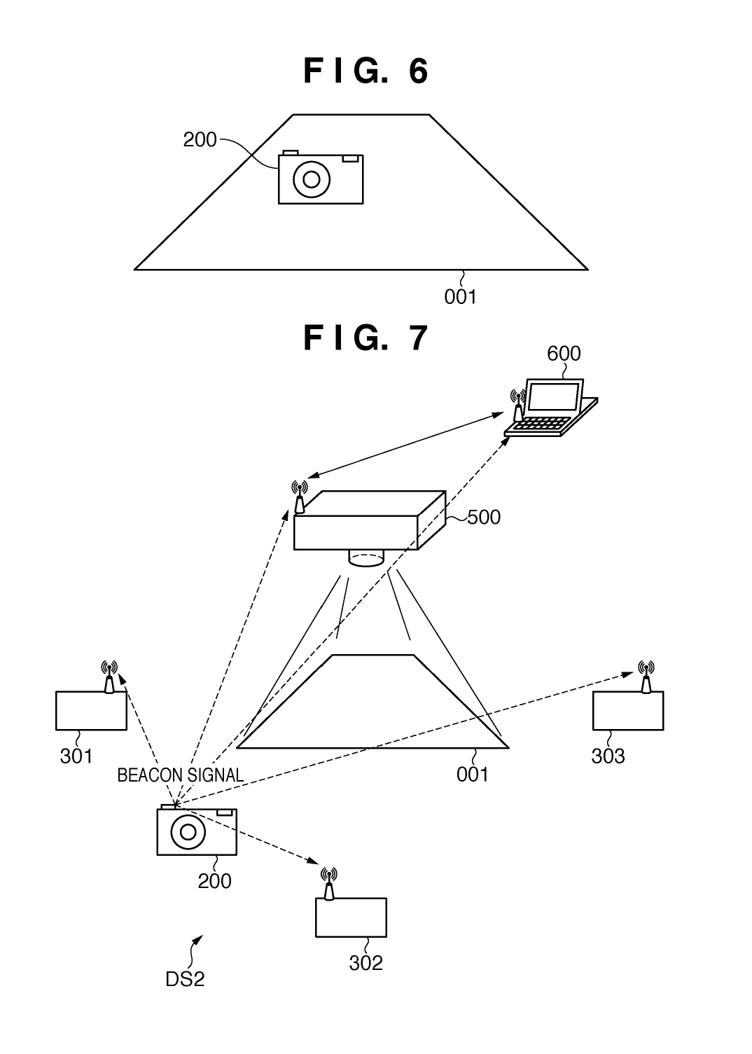

The controller 101 discriminates whether the display apparatus 100 is set to authenticate the wireless terminal when it is placed on the projection screen 001 or as long as it exists above the projection screen (S110). That is, the controller 101 discriminates whether or not it is further required in the setting at the display apparatus 100 to identify if the wireless terminal 200 is placed on the projection screen 001 (see FIG. 6), in place of the user's finger, so as to authenticate the wireless terminal 200. If it is further required to identify if the wireless terminal 200 is placed on the projection screen 001 (YES in step S110), the controller 101 advances the process to step S111. If it is not further required to identify if the wireless terminal 200 is placed on the projection screen 001 (NO in step S110), the controller 101 jumps the process to step S113.

The controller 101 judges in step S111 to identify using the object identification program 113 whether or not the wireless terminal 200 is placed.

The object identification program 113 captures the projection screen 001 at constant intervals using, for example, the image capture unit included in the display apparatus 100. The object identification program discriminates the captured images using an immobile object detection technique used in, for example, a monitor camera. For example, when the captured image is compared with a previous frame and has a difference from the previous frame, an object is identified, and when the identified object does not move for a predetermined time period, that object is recognized as a placed object, that is, the wireless terminal in place of the user's finger. In addition, when the identified object is separated into a hand and the wireless terminal, it can be judged that the wireless terminal is placed. When the display apparatus 100 is suspended from the ceiling, the position of the wireless terminal can be three-dimensionally specified together with the three communication devices. Hence, it can be specified if the wireless terminal is placed. Alternatively, the position of the wireless terminal may be measured by beamforming. If it can be identified that the wireless terminal is placed (YES in step S111), the controller 101 advances the process to step S113; otherwise (NO in step S111), it returns the process to step S108.

When image data of the display apparatus 100 is projected onto the projection screen 001, a communication partner of the wireless terminal 200 is the display apparatus. When an image is received from the information processing apparatus 400 and is projected, a communication partner of the wireless terminal 200 is the information processing apparatus 400. Hence, the controller 101 judges whether the communication partner of the wireless terminal 200 is the display apparatus 100 or the information processing apparatus 400 (S113). If the communication partner of the wireless terminal 200 is the display apparatus 100 (YES in step S113), the controller 101 advances the process to step S114; if the communication partner of the wireless terminal 200 is the information processing apparatus 400 (NO in step S113), it advances the process to step S115. In step 5114, the controller 101 allows the communication unit 120 to communicate with the wireless terminal 200. That is, the controller 101 controls the communication unit 120 to exchange a series of setting signals such as a probe request signal and authentication signal of a MAC frame, which are defined by the wireless LAN 802.11 standard, with the wireless terminal 200. Then, the controller 101 sets up a communication state with the wireless terminal 200 (S114). After that, a communication is made by a normal authentication method between wireless devices.

In step S115, the controller 101 allows the communication unit 120 to communicate with the wireless terminal 200 via the information processing apparatus 400. That is, the communication unit 120 is already allowed to communicate with the information processing apparatus 400. The controller 101 controls the communication unit 120 to transmit a signal that allows a communication with the wireless terminal 200 to the information processing apparatus 400. Assume that a connection between the information processing apparatus 400 and display apparatus 100 is established in advance, and a communication allowance signal is transmitted using an arbitrary command. Upon reception of this signal, the information processing apparatus 400 exchanges a series of setting signals such as a probe request signal and authentication signal with the wireless terminal 200. Then, the information processing apparatus 400 sets up a communication state with the wireless terminal 200 (S115). That is, exchange of data such as image data other than those required to establish a communication is allowed.

The aforementioned embodiment can provide a system which allows a communication by simply placing the wireless terminal on the projection screen upon authenticating the wireless terminal. That is, according to this embodiment, a connection between the wireless terminal and display apparatus can be established by simple processing.

As for an authentication method of this embodiment, a MAC frame is used. Alternatively, authentication may be complete in a MAC layer, and whether or not to allow a communication may be determined in an upper protocol layer. This embodiment is applicable to a plurality of wireless terminals 200. Even when three or more communication devices 301 to 303 are not arranged around the display screen 001, the display apparatus can detect the position of the wireless terminal. In the example of this embodiment, the projector is used as the display apparatus. However, this embodiment may be applied to a display or television, as long as it can display a screen.

### Second Embodiment

A schematic arrangement of a display system DS2 according to the second embodiment of the present invention will be described below with reference to FIG. 7. Differences from the first embodiment will mainly be described below.

In the first embodiment, the display apparatus 100 discriminates the position of the wireless terminal 200, and then authenticates the wireless terminal 200. In the second embodiment, an information processing apparatus discriminates the position of a wireless terminal, and then authenticates the wireless terminal.

The display system DS2 includes a display apparatus 500 and information processing apparatus 600, as shown in FIG. 7. The information processing apparatus 600 is allowed to communicate with the display apparatus 500. The information processing apparatus 600 transmits image data to the display apparatus 500. Then, the display apparatus 500 receives image data from the information processing apparatus 600, and projects and displays an image according to the received image data onto a projection screen 001.

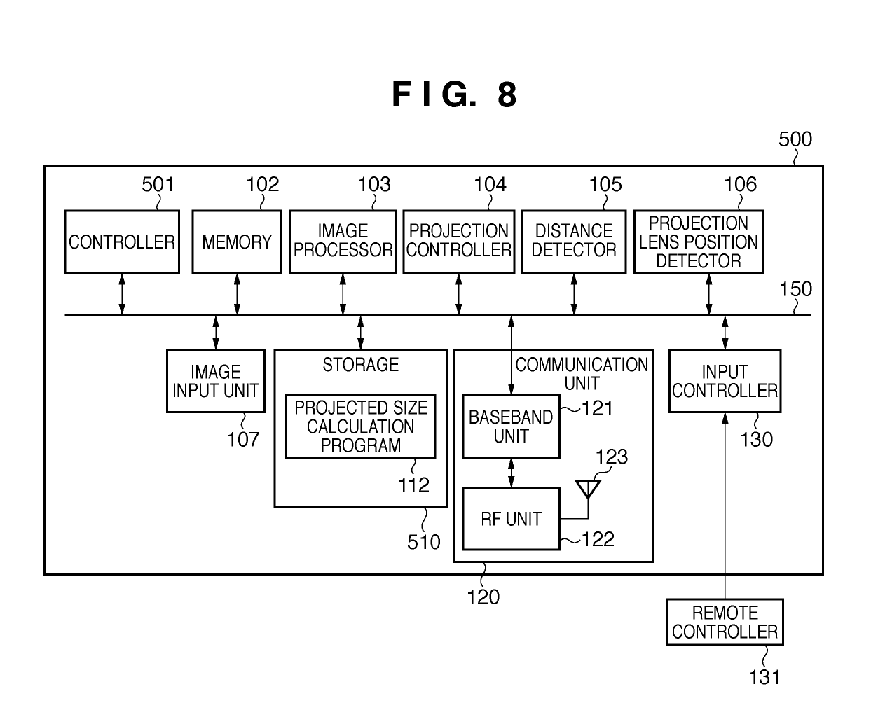

As shown in FIG. 8, the display apparatus 500 includes a storage 510 and controller 501.

The storage 510 stores neither the position detection program 111 nor the object identification program 113 (see FIG. 2). The position detection program and object identification program are stored in a storage 610 of the information processing apparatus 600, as will be described later.

A position detector, discrimination unit, and controller are included in a CPU (controller) 601 of the information processing apparatus 600, as will be described later.

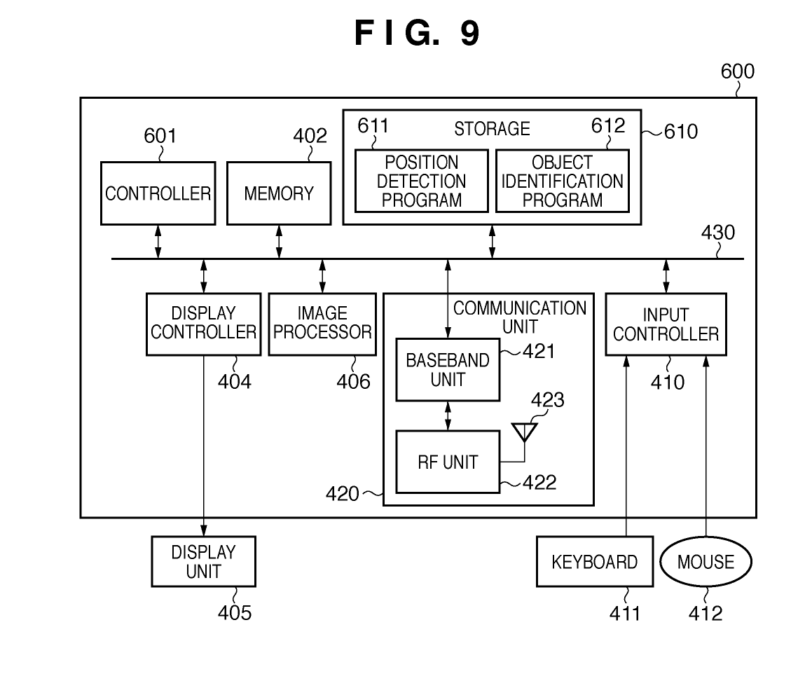

As shown in FIG. 9, the information processing apparatus 600 includes the storage 610 and controller 601.

The storage 610 stores a position detection program 611 required to specify the position of a wireless terminal 200, and an object identification program 612 required to judge whether or not the wireless terminal 200 is placed on the projection screen 001 of the display apparatus 500.

The controller 601 manages the projection screen (display screen) 001 on which a projection controller 104 of the display apparatus 500 projects and displays an image via a communication unit (second communication means) 420. In this case, the communication unit 420 is allowed to communicate with the display apparatus 500.

The controller 601 detects the position of the wireless terminal 200. More specifically, the communication unit (second communication means) 420 receives, from the wireless terminal 200, a beacon signal which is periodically transmitted from the wireless terminal 200 in a state in which a communication with the wireless terminal 200 is not allowed. In addition, the communication unit 420 receives the beacon signal from the wireless terminal 200 via a minimum of three communication devices 301 to 303 arranged around the projection screen 001.

Then, the controller 601 discriminates whether or not the wireless terminal 200 contacts the display screen 001 according to the detected position of the wireless terminal 200 and the managed display screen 001.

When it is discriminated that the wireless terminal 200 contacts the display screen 001, the controller 601 allows the communication unit 420 to communicate with the wireless terminal 200.

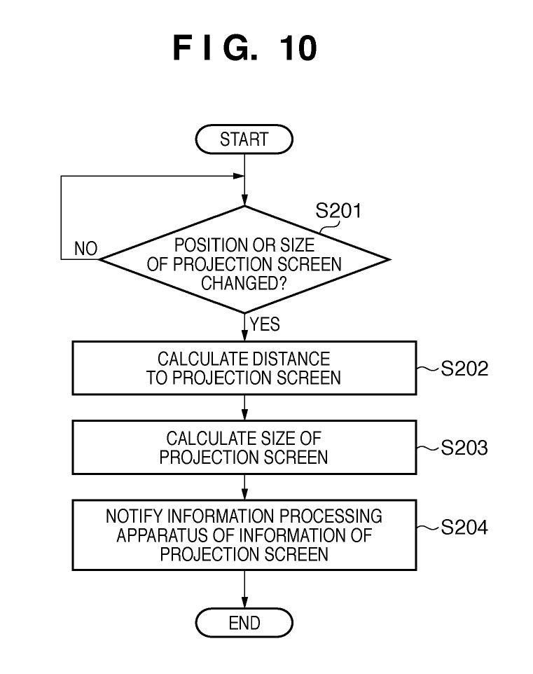

The sequence of processing executed from when the display apparatus 500 calculates a projected size until it notifies the information processing apparatus 600 of the calculated size will be described below with reference to FIG. 10.

The controller 501 of the display apparatus 500 discriminates whether or not at least one of the position and size of the projection screen has been changed from the projected projection screen due to movement of the main body of the display apparatus 500 or shifting or enlarging of a lens (S201). If at least one of the position and size of the projection screen has been changed (YES in step S201), the controller 501 advances the process to step S202; otherwise (NO in step S201), it waits for the change. Note that when the program is launched for the first time, the next step is executed immediately.

The controller 501 calculates the size of the projection screen by the same processing as that described above using FIG. 4 in the first embodiment. That is, in steps S202 and S203, the same processes as in steps S102 and S103 shown in FIG. 5 are respectively executed.

In step S204, a communication unit (first communication means) 120 receives information of the position and size of the projection screen from the controller 501. The communication unit 120 transmits the information of the position and size of the projection screen to the information processing apparatus 600.

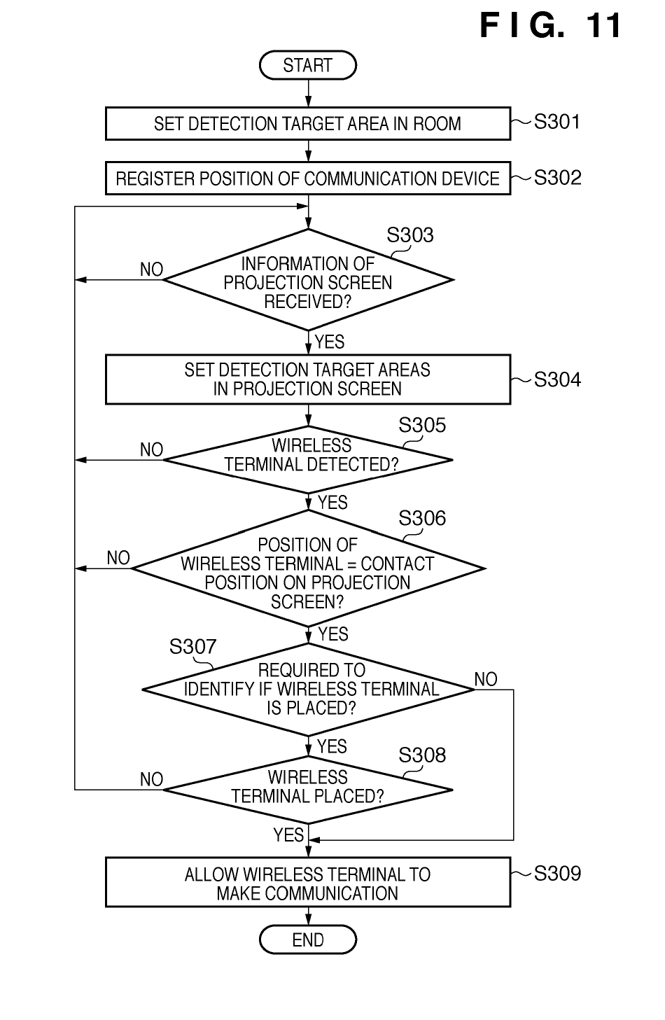

The sequence of processing executed until the information processing apparatus 600 authenticates a digital camera will be described below with reference to FIG. 11.

Assume that a wireless communication state between the display apparatus 500 and information processing apparatus 600 is set in advance, and the information processing apparatus 600 is set in advance to be able to detect the position of the display apparatus 500. The controller 601 of the information processing apparatus 600 sets the position of the projection screen of the display apparatus 500 in a room as a rough detection area to have, as a base point, an installation location of the display apparatus 500 using an application of the information processing apparatus 600 (S301). This is to designate a range of the room that can be used as the detection area when at least one of the position and size of the projection screen has been changed from that of the initially projected projection screen due to movement of the main body of the display apparatus 500 or shifting or enlarging of the lens. The range is designated on a predetermined operation screen by receiving inputs from input devices such as a keyboard 411 and mouse 412 connected to the information processing apparatus 600 by an input controller 410. Next, the controller 601 receives pieces of information of the positions of the communication devices 301 to 303 from the input devices such as the keyboard 411 and mouse 412, and registers them in a memory 402 so as to detect the position of the wireless terminal (S302). That is, the pieces of registered position information of the communication devices 301 to 303 are stored in the memory 402.

After completion of the settings, if the communication unit (second communication means) 420 does not receive any information of the projection screen from the display apparatus 500 (NO in step S303), the controller 601 waits for that information. If the information of the projection screen is received from the display apparatus 500 (YES in step S303), the controller 601 advances the process to step S304.

The controller 601 sets detailed detection areas (detection target areas of the position of the wireless terminal) within the projection screen range according to the received information of the projection screen (S304). This setting processing is executed from the input devices via the input controller 410.

Since it is ready to detect the position with the aforementioned steps, the controller 601 begins to detect the position of the wireless terminal according to the position detection program 611 (S305).

More specifically, the communication unit 420 receives a beacon signal directly from the wireless terminal 200, and also from the wireless terminal 200 via the minimum of three communication devices 301 to 303 arranged around the projection screen 001. The controller 601 detects the position of the wireless terminal 200 according to the beacon signal from the wireless terminal 200 received by the communication unit 420 and that from the wireless terminal 200 received by the communication unit 420 via the at least three communication devices 301 to 303.

Next, the controller 601 discriminates according to the detected position of the wireless terminal 200 whether or not the detected wireless terminal 200 contacts the display screen 001. More specifically, the controller 601 discriminates whether or not the wireless terminal 200 is located within the detection area set in step S304 (S306). The discrimination method is the same as that in step S109 shown in FIG. 5.

If the wireless terminal 200 is not located within the detection area of the projection screen 001 (NO in step S306), the controller 601 returns the process to step S303 to check a change in projection screen. If the wireless terminal 200 is located within the detection area (YES in step S306), the controller 601 advances the process to step S307.

The controller 601 discriminates whether or not the display apparatus 500 is further required to identify if the wireless terminal 200 is placed on the projection screen 001 (see FIG. 6), in place of the user's finger, so as to authenticate the wireless terminal 200 (S307). If it is further required to identify if the wireless terminal 200 is placed on the projection screen 001 (YES in step S307), the controller 601 advances the process to step S308. If it is not further required to identify if the wireless terminal 200 is placed on the projection screen 001 (NO in step S307), the controller 601 jumps the process to step S309.

The controller 601 judges in step S308 to identify using the object identification program 612 whether or not the wireless terminal 200 is placed. The detailed processing contents are the same as those in step S111 shown in FIG. 5. If it can be identified that the wireless terminal is placed (YES in step S308), the controller 601 advances the process to step S309; otherwise (NO in step S308), it returns the process to step S303.

In step S309, the controller 601 allows the communication unit 420 to communicate with the wireless terminal 200.

### Third Embodiment

A display system DS1i according to the third embodiment of the present invention will be described below. Differences from the first embodiment will be mainly described below.

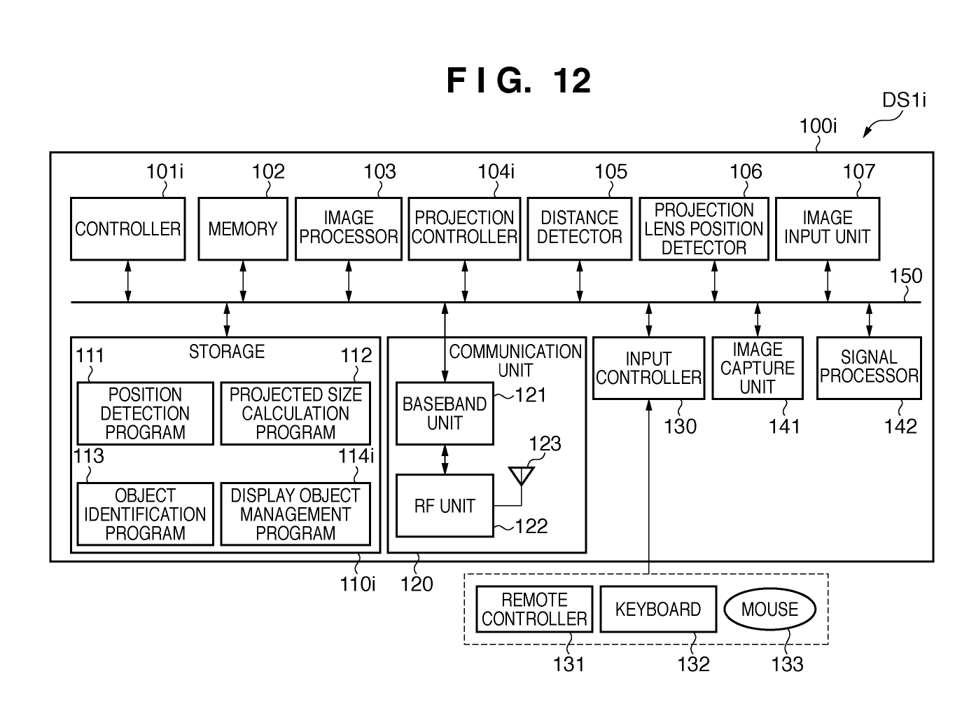

The display system DS1i includes a display apparatus 100i. As shown in FIG. 12, the display apparatus 100i includes a projection controller 104i, storage 110i, and controller 101i.

The projection controller 104i displays display objects associated with predetermined means or apparatuses within a display screen 001 (see FIG. 1) (within the display screen).

The storage 110i stores a display object management program 114i. The display object management program 114i is used to manage display objects which are projected by the projection controller 104i onto the projection screen 001. The display object management program 114i is used to perform various operations depending on the type of each object and the type and status of a wireless terminal based on the position information of that display object when the wireless terminal is placed on an object projected position.

The controller 101i discriminates according to the detected position of a wireless terminal 200 whether or not the wireless terminal 200 overlaps a control area including a display object within the display screen 001.

When the controller 101i discriminates according to the detected position of the wireless terminal 200 that the wireless terminal 200 overlaps the control area, it executes the following control. The controller 101i controls the wireless terminal 200 and the predetermined means or apparatus to perform operations associated with the wireless terminal 200 and display object. In this case, the operation associated with the wireless terminal 200 includes an operation associated with at least one of the type and status of the wireless terminal 200. The operation associated with the display object includes an operation associated with at least one of the type and status of the predetermined means or apparatus.

For example, a case will be examined below wherein the predetermined means or apparatus includes the projection controller (display means) 104i. When it is discriminated that the detected wireless terminal 200 overlaps the control area, the controller 101i executes the following control. The controller 101i controls a communication unit 120 to receive data from the wireless terminal 200, and the projection controller (display means) 104i to project and display an image according to the received data on the display screen 001. For example, a case will be examined below wherein the predetermined means or apparatus includes the storage (storage means) 110i. When it is discriminated that the detected wireless terminal 200 overlaps the control area, the controller 101i executes the following control. The controller 101i controls the communication unit 120 to receive data from the wireless terminal 200, and the storage (storage means) 110i to store the received data.

For example, a case will be examined below wherein the predetermined means or apparatus includes an information processing apparatus 400. When it is discriminated that the detected wireless terminal 200 overlaps the control area, the controller 101i executes the following control. The controller 101i controls the communication unit 120 to receive data from the wireless terminal 200, and also to transmit the received data to the information processing apparatus 400.

The controller 101i discriminates whether or not at least one of the position and size of the projection screen has been changed. When it is discriminated that at least one of the position and size of the projection screen has been changed, the controller 101i changes the information of control areas to be used to fit the changed projection screen.

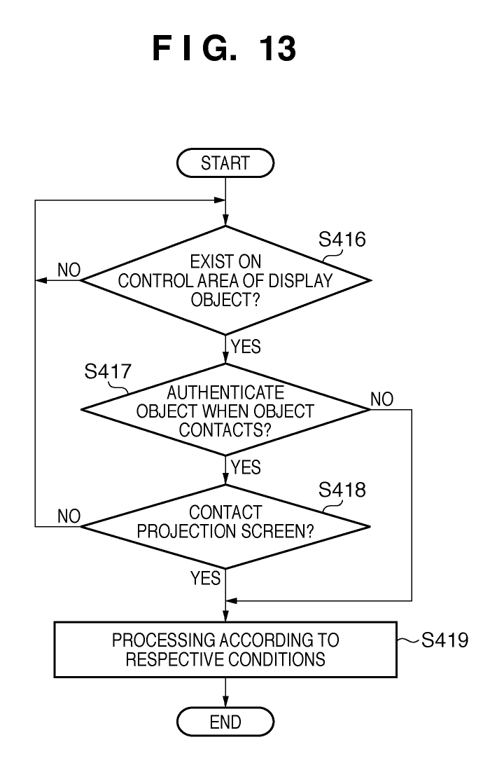

The sequence for executing operation processing such as data transmission/reception with the display apparatus 100i or information processing apparatus 400 when the wireless terminal 200 is set on a control area specified by an object displayed on the projection screen 001 will be described below with reference to FIG. 13. The controller 101i discriminates whether or not the communication-allowed wireless terminal 200 exists within one of the control areas of display objects within the projection screen 001 (overlaps the control area) (S416).

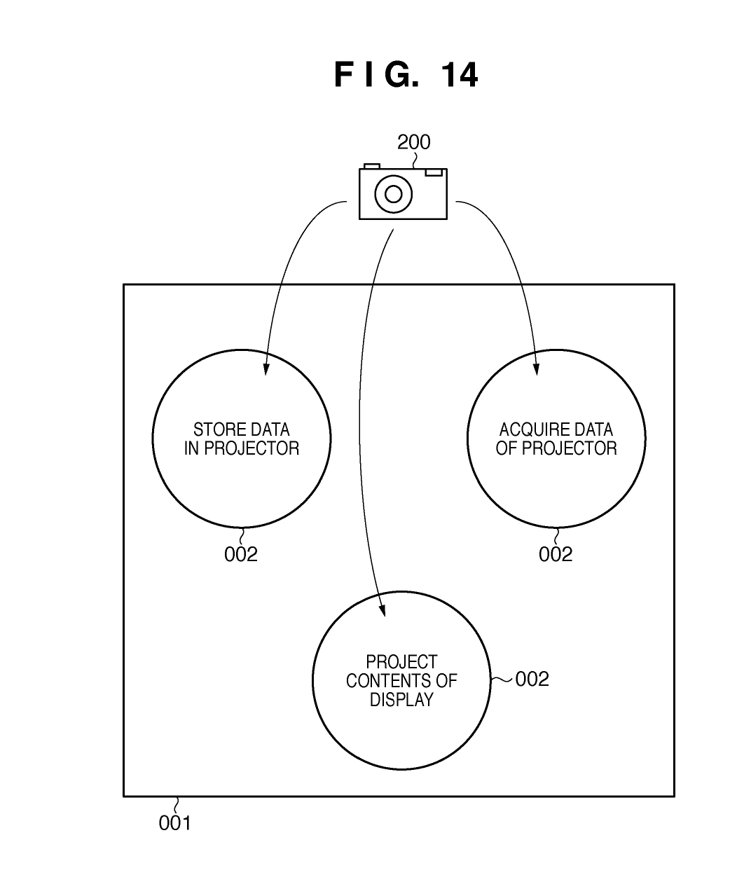

In this case, when image data of the display apparatus 100i is projected onto the projection screen 001, the projected display objects are, for example, display objects 002 as shown in FIG. 14. These display objects 002 are generated by the display object management program 114i, and are projected and displayed on the projection screen 001 via the projection controller 104i. In this case, the control area corresponds to a range specified according to the type of each display object. The display object management program 114i judges whether or not the position of the wireless terminal 200 acquired by a position detection program 111 falls within this range of the control area, and then determines whether or not to execute the subsequent processing. Note that in case of the display object 002 shown in FIG. 14, areas corresponding to locations where the display objects 002 are respectively projected and displayed are set as control areas.

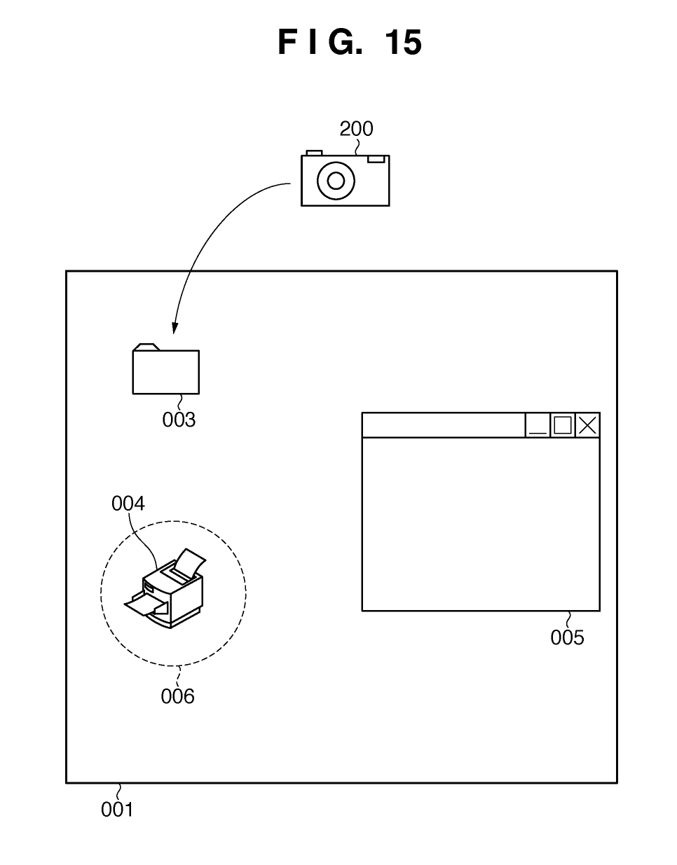

When an image from the information processing apparatus 400 is projected on the projection screen 001, the projected display objects are, for example, various icons 003 and 004 and a window 005 shown in FIG. 15. These display objects 003 to 005 are included in an image input from the information processing apparatus 400, and are projected and displayed on the projection screen 001 via the projection controller 104i. At this time, the controller 101i acquires information associated with the types and positions of the display objects from the information processing apparatus 400 in addition to the image from the information processing apparatus 400 according to the display object management program 114i, thereby managing the information of the display objects which are being currently projected and displayed on the projection screen 001. A control area in this case is a range specified according to the type of each display object, as described above. In this case, for example, the printer icon 004 may be projected while being enlarged to an image larger than the display range of the printer icon 004 like a control area 006 shown in FIG. 15 to allow easy detection when the wireless terminal 200 is placed. In this case, the size of the icon may be changed in accordance with that of the wireless terminal 200. In this case as well, the display object management program 114i judges according to the position of the wireless terminal 200 acquired by the position detection program 111 whether or not the wireless terminal 200 falls within the range of this control area, and then determines whether or not to execute the subsequent processing.

If the controller 101i discriminates that the wireless terminal 200 exists within the control area of the display object (YES in step S416), it advances the process to step S417. If the controller 101i discriminates that the wireless terminal 200 does not exist within the control area of the display object (NO in step S416), it repeats the process in step S416.

The controller 101i discriminates based on the settings of the display apparatus 100i whether the subsequent processing is executed when the wireless terminal 200 contacts the projection screen 001 or when it merely exists above the projection screen (S417).

If the subsequent processing is executed when the wireless terminal 200 contacts the projection screen 001 (YES in step S417), the controller 101i controls an object identification program 113 to detect if the wireless terminal 200 contacts the projection screen 001 in place of a user's finger (S418). This process is the same as that in step S111 shown in FIG. 5. If the controller 101i can detect that the wireless terminal 200 contacts the projection screen 001 (YES in step S418), it advances the process to step S419; otherwise (NO in step S418), it returns the process to step S416.

In step S419, the controller 101i controls the wireless terminal 200 and predetermined means or apparatus to execute the operations associated with the wireless terminal 200 and display object. For example, the controller 101i executes processing according to, for example, the type of the display object and the status of the wireless terminal 200, which are associated with the control area where the wireless terminal 200 exists. In this case, the device information and device status information of the wireless terminal 200 can be determined based on a beacon signal received by the communication unit 120. In another method, after a communication is allowed, an instruction signal which instructs to transmit the device information and device state information of the wireless terminal 200 may be transmitted, and the device information and device state information transmitted from the wireless terminal 200 may be received and determined.

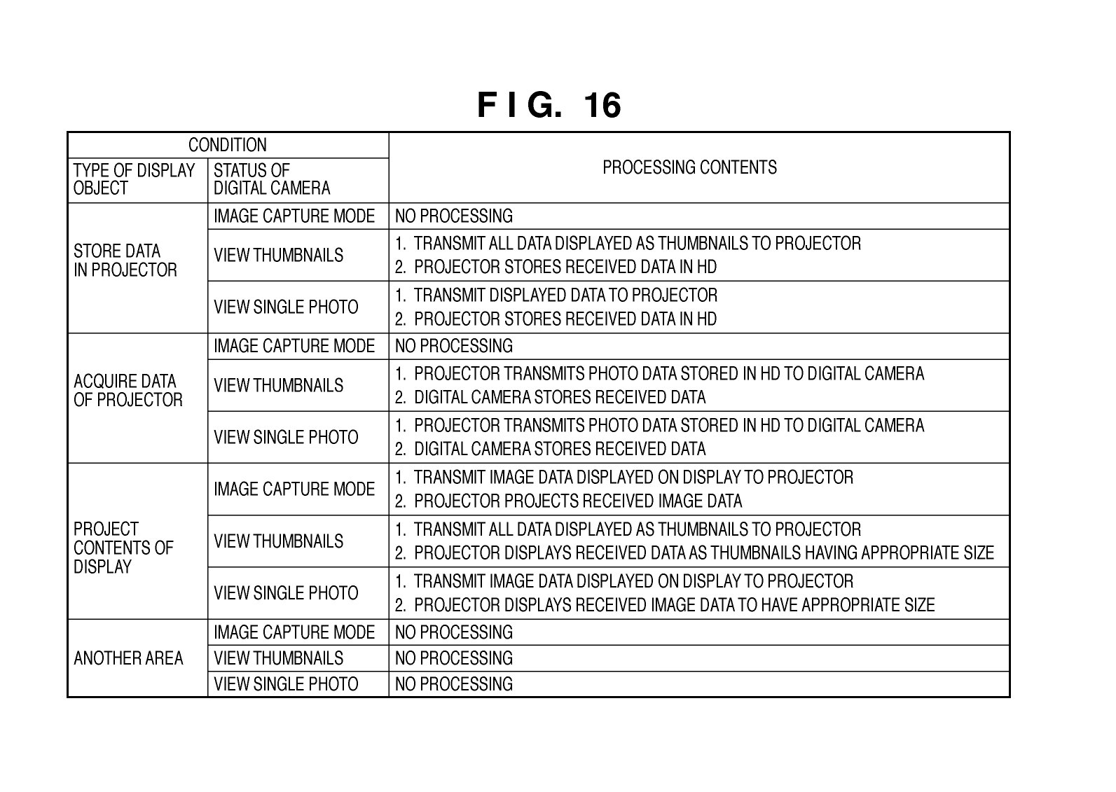

As shown in FIG. 14, when the wireless terminal 200 is brought into contact with the projection screen 001 on which image data of the display apparatus 100i is projected, the controller 101i controls the display object management program 114i to execute the following processing. The controller 101i executes processing between the wireless terminal 200 and display apparatus 100i according to various conditions, as in a table shown in FIG. 16.

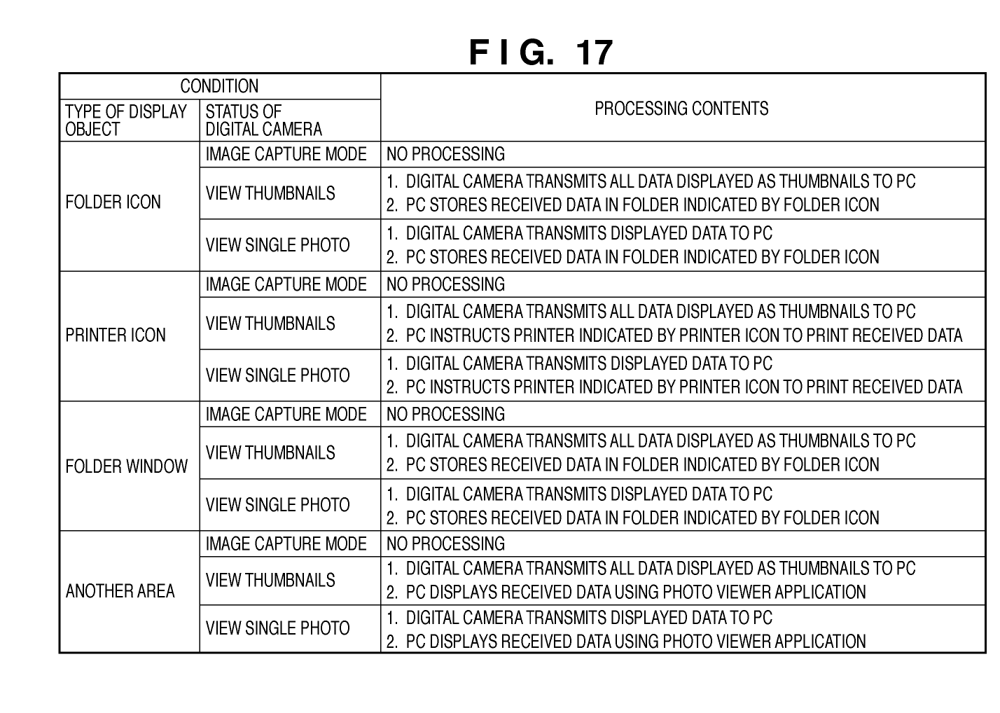

As shown in FIG. 15, when the wireless terminal 200 is brought into contact with the projection screen 001 on which image data from the information processing apparatus 400 is projected, the controller 101i controls the display object management program 114i to execute the following processing. The controller 101i executes processing between the wireless terminal 200 and information processing apparatus 400 according to various conditions, as in a table shown in FIG. 17.

Note that the processes according to various conditions shown in FIGS. 16 and 17 are merely examples, and do not limit this embodiment.

For example, when the wireless terminal contacts a control area of an icon indicating a folder in the information processing apparatus, processing may be executed to exchange or synchronize data between the information processing apparatus and wireless terminal.

For example, when the wireless terminal contacts a control area of an icon indicating a printer, processing may be executed to transmit data from the wireless terminal to the printer, and to execute print or print reservation processing of that data. Alternatively, when an identical image is to be printed, processing may be executed to designate the number of copies to be printed of that image (without repetitively transmitting the image).

For example, when the wireless terminal contacts a control area of a desktop in the information processing apparatus, processing may be executed to capture a desktop screen image or to generate and display a folder for the wireless terminal (that folder serves as a shortcut, and when data is stored in that folder, the data is automatically transferred).

For example, when the wireless terminal is a mobile phone, an arrangement that exports and imports bookmarks of both the apparatuses by allocating a mobile phone on a browser icon may be used. That is, when the wireless terminal contacts a control area of a browser, processing may be executed to import or export favorites. Alternatively, processing may be executed to open a homepage that displays information of the wireless terminal (to transfer a URL from the communication apparatus side to the display apparatus).

For example, when the display apparatus (projector) projects arbitrary characters, and the wireless terminal contacts a control area of each character, processing may be executed so that the wireless terminal transmits information (for example, game data) associated with that character to the display apparatus or information processing apparatus.

For example, when the wireless terminal (mobile phone) contacts a control area of an icon indicating an IP phone, processing may be executed to allow that wireless terminal to be used as a telephone set for the IP phone.

For example, by allocating the mobile phone on a desktop area which is being projected, the mobile phone may receive a screen which is being displayed by the information processing apparatus, and may display it on its display.

In addition, when the wireless terminal is a Personal Digital Assistant (to be abbreviated as a PDA hereinafter) having functions equivalent to the information processing apparatus, the following processing may also be executed. By allocating the PDA on the desktop area which is being projected, an application which has the same function as that of an application which is currently running on the PDA may also be launched on the information processing apparatus side, and the information processing apparatus may receive data which is being currently used by the application of the PDA from the PDA. Then, by processing the received data by the application of the information processing apparatus, the information processing apparatus and PDA may be set in an equivalent operation state.

As described above, according to this embodiment, various arrangements are allowed depending on the type and status of the wireless terminal and the type of the projected display object where the wireless terminal is allocated. More specifically, according to this embodiment, processing associated with an object displayed on the projection screen by the projection apparatus can be executed in response to an operation for placing the wireless terminal on the projection screen. In this manner, the user can exchange data between the projection apparatus and wireless terminal by a simple operation.

### Fourth Embodiment

A display system DS2i according to the fourth embodiment of the present invention will be described below. Differences from the second and third embodiments will mainly be described below.

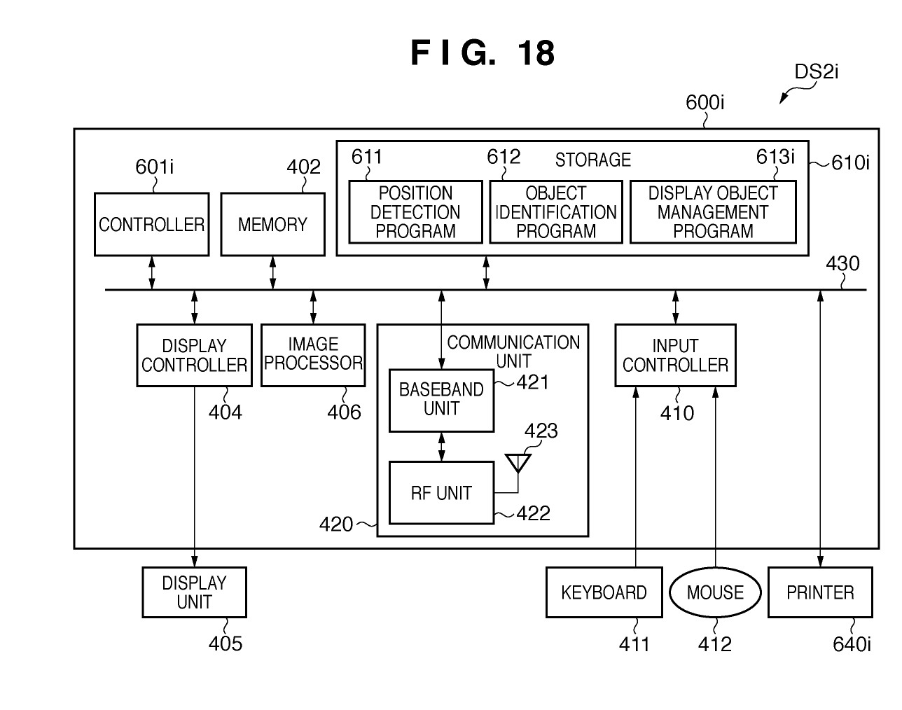

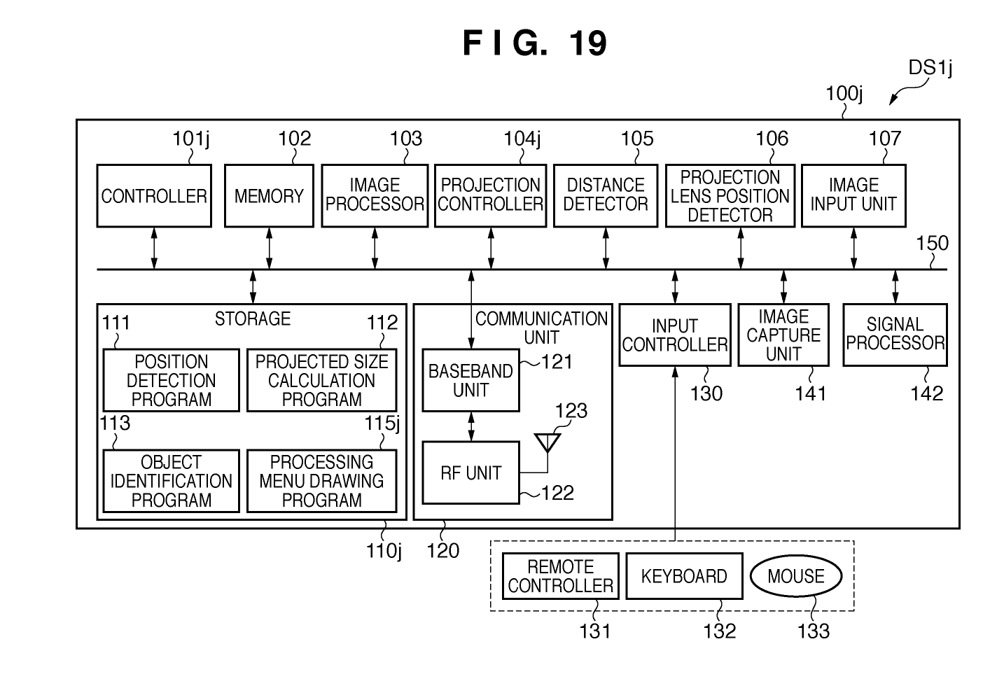

The display system DS2i includes an information processing apparatus 600i. As shown in FIG. 18, the information processing apparatus 600i includes a storage 610i, printer (print means) 640i, and controller 601i.

The storage 610i stores a display object management program 613i. The display object management program 613i is used to manage display objects projected onto a projection screen 001 by a projection controller 104. The display object management program 613i is used to perform various operations according to the type of each object, and the type and status of a wireless terminal based on the position information of that display object when the wireless terminal is placed at an object projected position.

The printer 640i prints data to be printed according to a print instruction, as and when it receives the print instruction and data to be printed from the controller 601i.

The controller 601i controls the projection controller 104 in a display apparatus 100 via a communication unit 420 so as to display, within the display screen 001, display objects associated with predetermined means or apparatuses.

The controller 601i discriminates according to the detected position of a wireless terminal 200 and the managed display screen 001 whether or not the wireless terminal 200 overlaps a control area including a display object within the display screen 001.

When the controller 601i discriminates that the wireless terminal 200 overlaps the control area, it controls the wireless terminal 200 and predetermined means or apparatus so as to perform operations associated with the wireless terminal 200 and display object.

For example, a case will be examined below wherein the predetermined means or apparatus includes the projection controller (display means) 104 in the display apparatus 100. When the controller 601i discriminates that the wireless terminal 200 detected by a position detection program 611 overlaps a control area, it executes the following control. The controller 601i controls the communication unit 420 to receive data from the wireless terminal 200, and the projection controller (display means) 104 to display an image according to the received data on the display screen 001 via the communication unit 420.

For example, a case will be examined below wherein the predetermined means or apparatus includes the storage (storage means) 610i. When the controller 601i discriminates that the detected wireless terminal 200 overlaps a control area, it executes the following control. The controller 601i controls the communication unit 420 to receive data from the wireless terminal 200, and also the storage (storage means) 610i to store the received data.

For example, a case will be examined below wherein the predetermined means or apparatus includes the printer (print means) 640i. When the controller 601i discriminates that the detected wireless terminal 200 overlaps a control area, it executes the following control. The controller 601i controls the communication unit 420 to receive data from the wireless terminal 200, and also the printer (print means) 640i to print the received data.

### Fifth Embodiment

A display system DS1j according to the fifth embodiment of the present invention will be described below. Differences from the first embodiment will be mainly described below.

The display system DS1j includes a display apparatus 100j. The display apparatus 100j includes a storage 110j, controller 101j, and projection controller 104j.

The storage 110j stores a processing menu drawing program 115j. The processing menu drawing program 115j is used to display a processing menu associated with a wireless terminal when the wireless terminal is placed on a projection screen 001 of the display apparatus 100j.

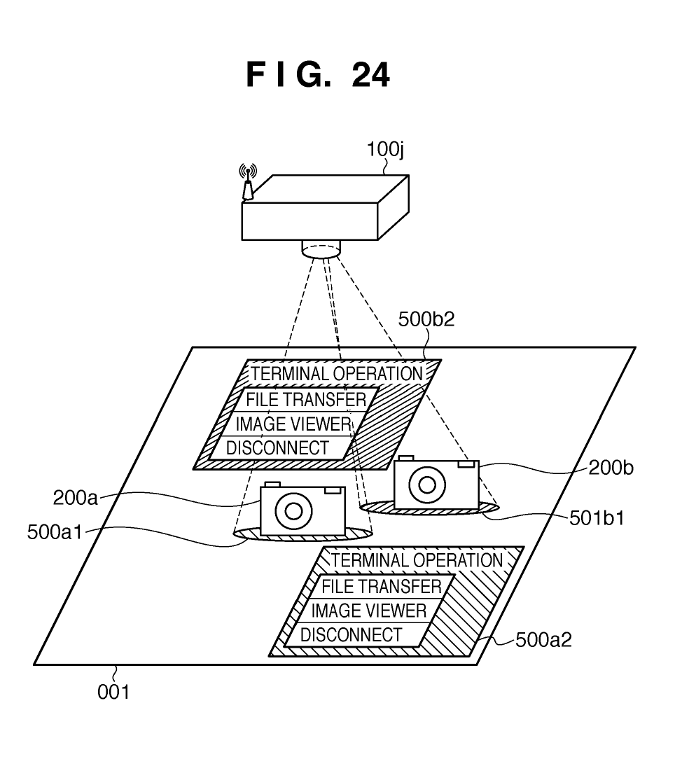

The controller 101j can allow a communication unit 120 to communicate with a plurality of wireless terminals 200a and 200b (see FIG. 24).

When the controller 101j allows the communication unit 120 to communicate with the plurality of wireless terminals 200a and 200b, the projection controller 104j is controlled by the controller 101j to execute the following operation. The projection controller 104j displays, in different formats, a plurality of first display objects 500a1 and 500b1 required to identify the respective wireless terminals at positions where the plurality of wireless terminals 200a and 200b are placed within the display screen 001 (see FIG. 24). In addition, the projection controller 104j displays a plurality of second display objects 500a2 and 500b2 associated with the plurality of wireless terminals in formats corresponding to the first display objects of the associated wireless terminals (see FIG. 24).

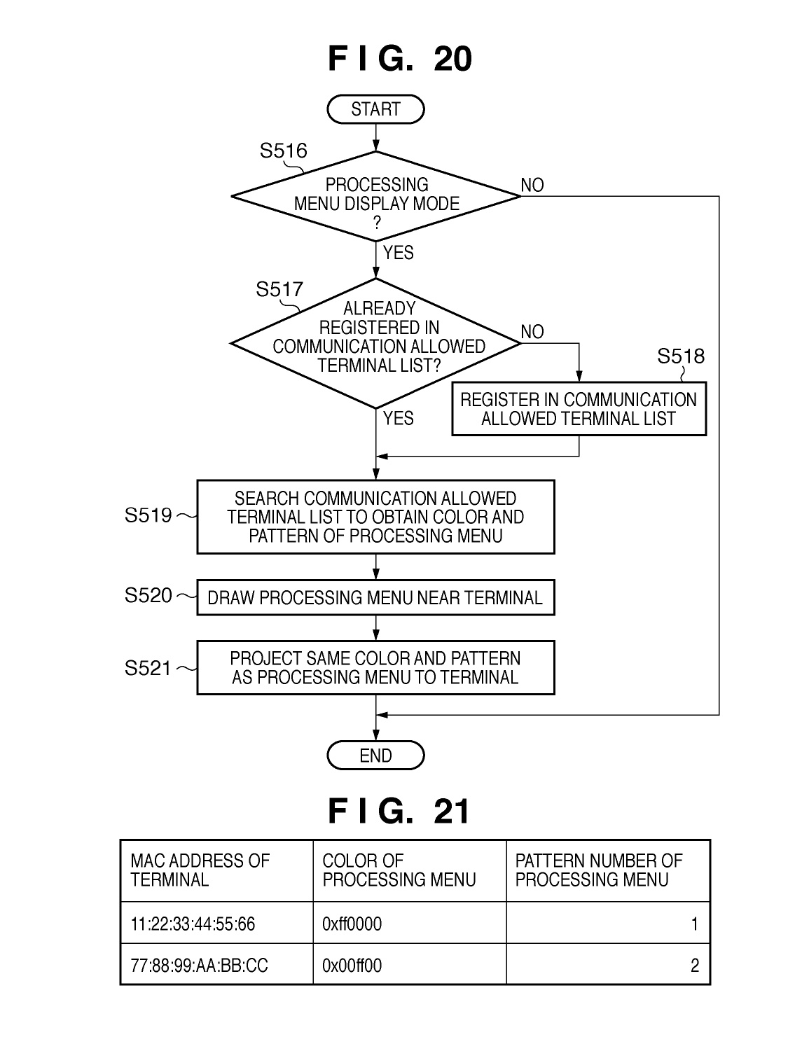

Processing menu display processing in the display apparatus 100j when the wireless terminal 200 contacts the projection screen 001 will be described below with reference to FIG. 20.

The controller 101j judges if a mode of displaying a processing menu is set (S516). Assume that whether or not the mode of displaying a processing menu is set at the communication allowance timing is set in advance in the display apparatus 100j. Note that whether or not to display a menu is set in the display apparatus 100j in this embodiment. Alternatively, such setting may be made in the wireless terminal 200.

If the mode of displaying a processing menu is not set (NO in step S516), the controller 101j ends the processing. If the mode of displaying a processing menu is set (YES in step S516), the controller 101j advances the process to step S517.

The controller 101j determines whether or not information of the wireless terminal has already been registered in a communication allowed terminal list shown in FIG. 21 (S517). If the information of the wireless terminal has already been registered (YES in step S517), the controller 101j advances the process to step S519; otherwise (NO in step S517), it advances the process to step S518.

In step S518, the controller 101j registers the information of the wireless terminal in the communication allowed terminal list. In registering a color and pattern colors and patterns which are similar to those already used in the communication allowed terminal list are avoided as much as possible, so as to allow easy discrimination of each wireless terminal.

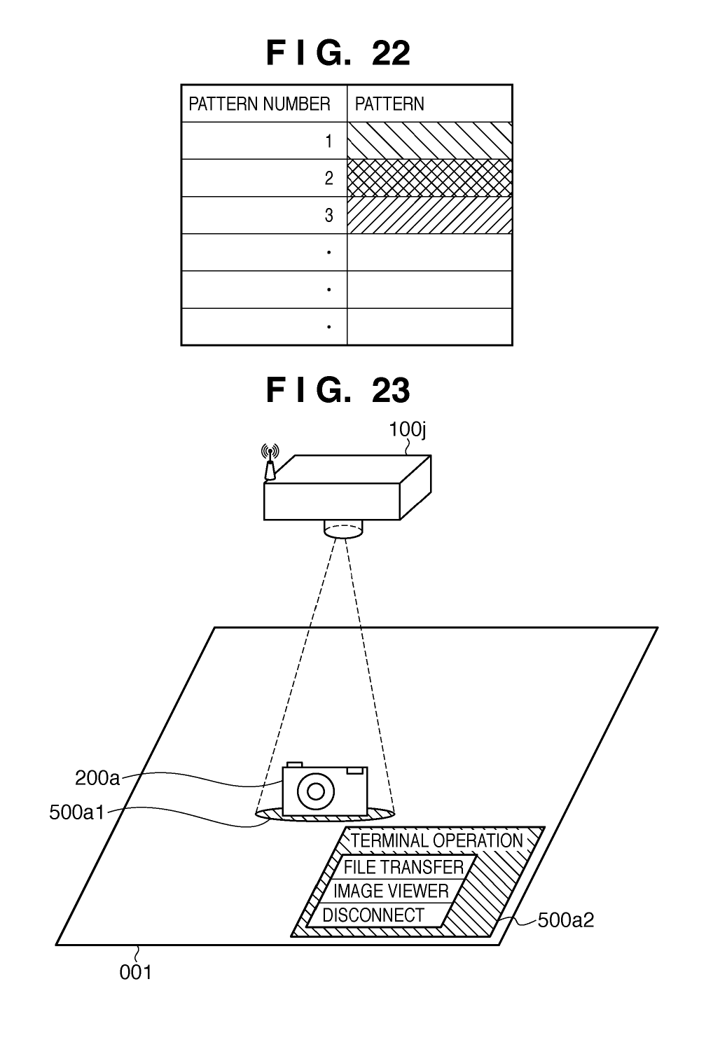

The communication allowed terminal list shown in FIG. 21 will be described in detail below. In the communication allowed terminal list, a MAC address required to uniquely identify a wireless terminal, and a menu color and pattern number associated with that wireless terminal are registered. In FIG. 21, each color is expressed by a hexadecimal number to record the first 1 byte as R data, the next byte as G data, and the last byte as B data. The pattern number in FIG. 21 is associated with a number of a pattern in a pattern list shown in FIG. 22.

Note that this embodiment uses a MAC address to uniquely identify a wireless terminal. Alternatively, data other than the MAC address may be used as long as it can uniquely identify a wireless terminal. In order to associate with a processing menu, both a color value and pattern number are used. However, either the color value or pattern number may be used. The shape, luminance, and transparency of a processing menu may be changed in addition to the color and pattern. The controller 101j then searches the communication allowed terminal list for a color and pattern of the processing menu to obtain the color and pattern of the processing menu (S519). The controller 101j draws the processing menu near the wireless terminal according to the processing menu drawing program 115j (S520), and projects to draw an object having the same color and pattern as those of the processing menu at the detected position of the wireless terminal (that is, on or near the wireless terminal) (S521), thus ending the processing.

Note that the same color and pattern as those of the processing menu are projected onto the wireless terminal in this embodiment. However, a similar color and pattern may be used within a range within which it can be discriminated that the wireless terminal and processing menu are associated with each other. Alternatively, an image capture unit may capture an image of the wireless terminal, and may enlarge or reduce the size of the display object in correspondence with that of the wireless terminal. The size may be obtained via a communication. Also, after the wireless terminal is moved, the object may be re-displayed at a position after movement. These control processes are executed by the controller 101j, as described above.

FIG. 23 is a view showing a state in which a communication of the wireless terminal 200a is allowed. The display apparatus 100j draws the processing menu 500a2 associated with the wireless terminal 200a, and projects the display object 500a1 having the same pattern on or near the wireless terminal 200a. In FIG. 23, the display object 500a1 having the same color and pattern as those of an outer frame of the processing menu 500a2 is projected on or near the wireless terminal 200a.

FIG. 23 shows an example of the processing menu 500a2. The processing menu 500a2 shown in FIG. 23 includes the menu items “file transfer”, “image viewer” and “disconnection” as an example. However, any other menu configurations may be adopted as long as they are associated with the wireless terminal.

In this embodiment, the outer frame of the processing menu is drawn to have the color and pattern registered in the communication allowed terminal list. Alternatively, the entire processing menu may be drawn to have the color and pattern registered in the communication allowed terminal list. Also, only a title bar or part of the processing menu may be drawn to have the color and pattern registered in the communication allowed terminal list.

FIG. 24 is a view showing a state in which a communication of another wireless terminal 200b is allowed from the state shown in FIG. 23. When a communication of the wireless terminal 200b is allowed, the display apparatus 100j assigns a new color and pattern to the wireless terminal 200b to draw the processing menu 500b2. After that, the display apparatus 100j projects the display object 500b1 having the same color and pattern as the processing menu 500b2 on or near the wireless terminal 200b.

With the above processing, even when there are a plurality of wireless terminals which can communicate with the display apparatus 100j, associations between the processing menus and wireless terminals can be easily discriminated. That is, according to this embodiment, even when objects associated with a plurality of wireless terminals are displayed, the association between the wireless terminals and the displayed objects can be easily recognized.

In the description of this embodiment, the processing menu associated with the wireless terminal is drawn at the communication allowance timing. Alternatively, files stored in the wireless terminal may be displayed. Upon displaying files, a frame or the like is displayed to have the same color and pattern, so as to reveal the relationship between the wireless terminals and files as in this embodiment. In addition to files in the wireless terminals, a content associated with the wireless terminal may be displayed. The content associated with the wireless terminal includes Web pages associated with the wireless terminal such as a support page of that wireless terminal and an upload site of still pictures and movies, and a help screen. Upon displaying a content associated with the wireless terminal, a frame may be displayed to have the same color and pattern on both the wireless terminal and content, so as to reveal the association between them as in this embodiment.

### Sixth Embodiment

A display system DS2j according to the sixth embodiment of the present invention will be described below. Differences from the first and fifth embodiments will be mainly described below.

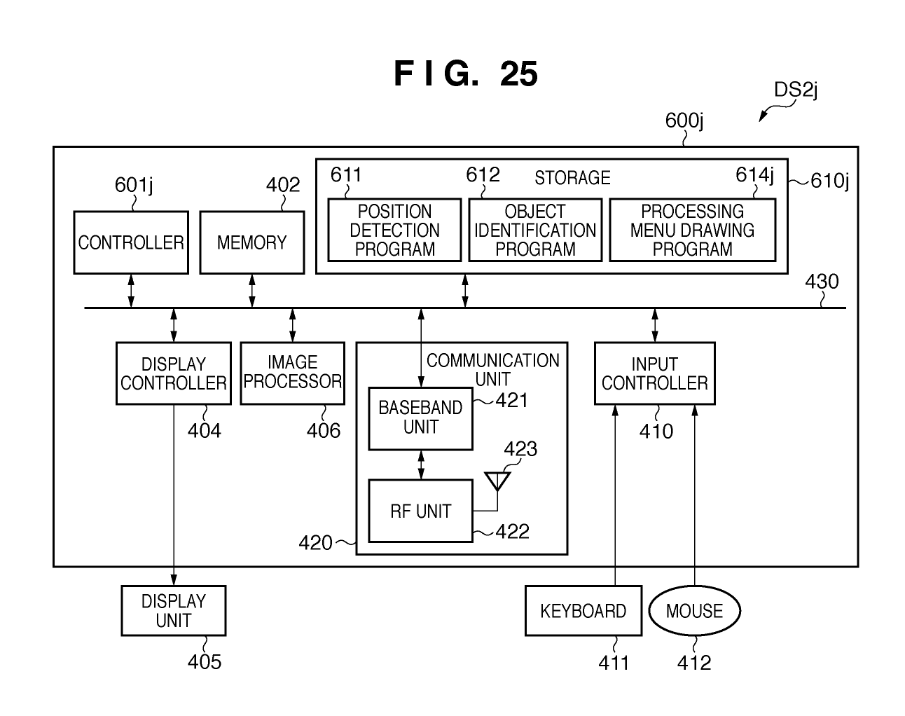

The display system DS2j includes an information processing apparatus 600j. As shown in FIG. 25, the information processing apparatus 600j includes a storage 610j and controller 601j.

The storage 610j stores a processing menu drawing program 614j. The processing menu drawing program 614j is used to display a processing menu associated with a wireless terminal when the wireless terminal is placed on a projection screen 001 of a display apparatus 100.

The controller 601j can allow a communication unit 420 to communicate with a plurality of wireless terminals 200a and 200b (see FIG. 24).

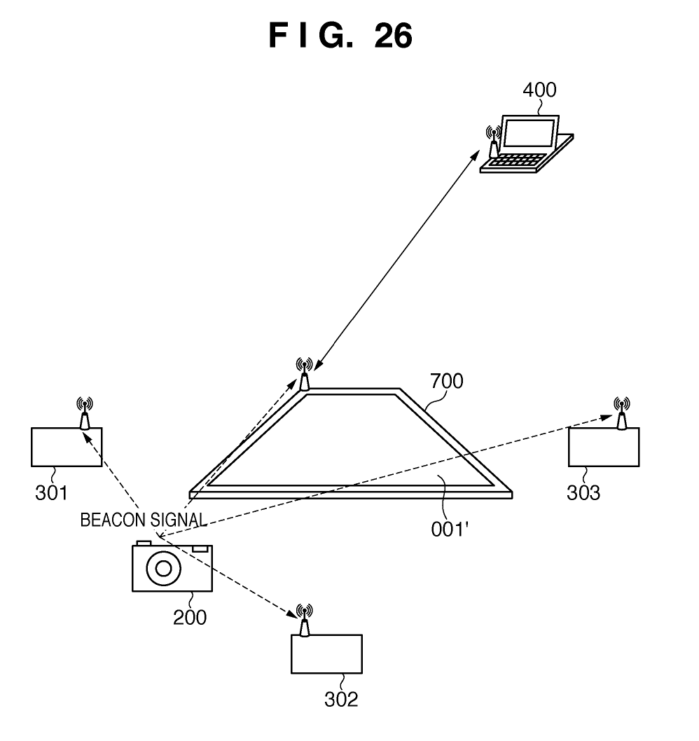

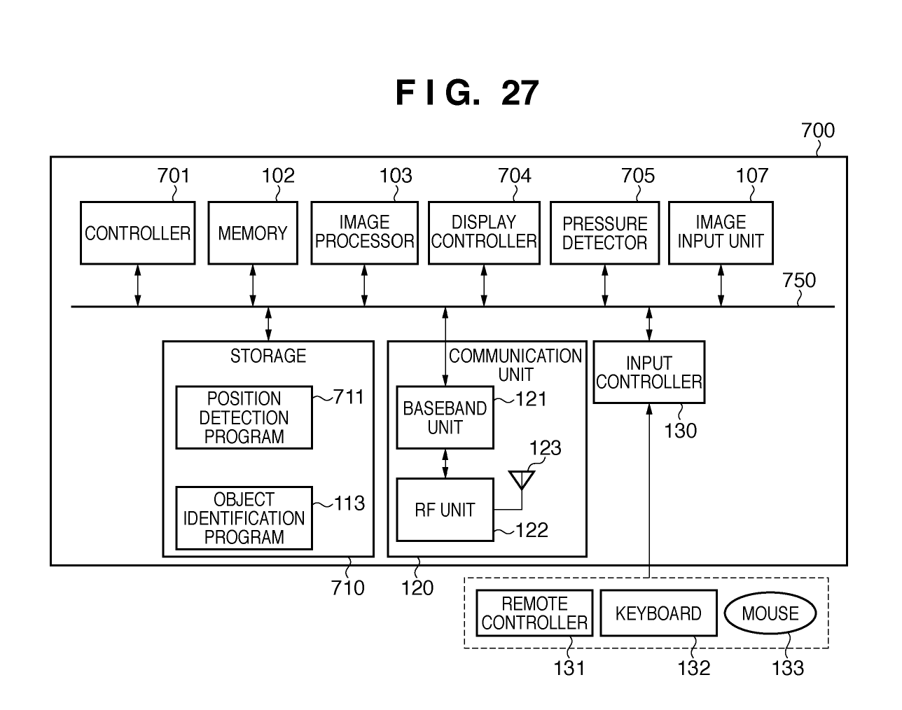

When the controller 601j allows the communication unit 420 to communicate with the plurality of wireless terminals 200a and 200b, it controls a projection controller 104 in the display apparatus 100 via the communication unit 420 to execute the following operation. The controller 601j controls to display a plurality of first display objects 500a1 and 500b1 required to identify the plurality of wireless terminals 200a and 200b in different formats in the display screen 001 (see FIG. 24). In addition, the controller 601j controls to display a plurality of second display objects 500a2 and 500b2 associated with the plurality of wireless terminals in the formats corresponding to the first display objects of the associated wireless terminals (see FIG. 24). Note that in the first to sixth embodiments, the display apparatus may have a display screen. Such display screen includes, for example, a television or display. That is, the display apparatus may have a display screen 001′ including a touch panel function, as shown in FIG. 26, in place of projecting light modulated according to image data onto a projection screen. That is, a display apparatus 700 shown in FIG. 26 includes a display controller 704, storage 710, and pressure detector 705, as shown in FIG. 27.

The display controller 704 executes liquid crystal panel control and ON/OFF control of a backlight under the control of a CPU (controller) 701, thus displaying an image on the display screen 001′.

The storage 710 does not store any projected size calculation program, but stores a position detection program 711. The position detection program 711 is used to detect the position of a wireless terminal via the pressure detector 705.

The pressure detector 705 includes, for example, a pressure sensor arranged on the back side of the display screen. The pressure detector 705 can acquire the distribution of a contact state, that is, position information when an object (wireless terminal) touches the display screen 001′ including the touch panel function.

Note that in this embodiment, touching of an object (wireless terminal) on the display screen 001′ including the touch panel function is detected using the pressure sensor. Alternatively, the distribution of a contact state of the wireless terminal on the display screen may be detected using the following method. For example, other touch detection methods generally used in a touch display such as a method using reflection of infrared light and a method of detecting a change in capacitance may be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-291400, filed Dec. 22, 2009, and which is hereby incorporated by reference herein in its entirety.

What is claimed is:

1. A projection apparatus for projecting an image on a display surface, comprising:
a projection unit adapted to project an image on the display surface;
a communication unit adapted to communicate with a communication terminal;
a detector adapted to detect a position of the communication terminal; and
a controller adapted to allow said communication unit to make data communication with the communication terminal, in response to the position of the communication terminal detected by said detector remaining unchanged for not less than a predetermined time period within a range in which the image is projected by said projection unit.

2. The apparatus according to claim 1, wherein said controller controls said projection unit to project a user interface corresponding to the communication terminal, in response to the position of the communication terminal remaining unchanged for not less than the predetermined time period within the range in which the image is projected by said projection unit.

3. The apparatus according to claim 1, wherein said detector detects the position of the communication terminal based on an image captured by an image capture unit adapted to capture an image of a projection range by said projection unit.

4. The apparatus according to claim 1, wherein said detector detects the position of the communication terminal based on signals which are output from the communication terminal and are received by not less than three communication devices.

5. The apparatus according to claim 2, wherein said controller controls said projection unit to project an image corresponding to the user interface at the detected position of the communication terminal.

6. The apparatus according to claim 2, wherein said controller controls said projection unit to project an image corresponding to the user interface on the communication terminal.

7. The apparatus according to claim 2, wherein said detector detects positions of a first communication terminal and a second communication terminal,
said controller projects a first user interface corresponding to the first communication terminal, and projects a second user interface corresponding to the second communication terminal, and
said controller projects a first image corresponding to the first user interface at the detected position of the first communication terminal, and projects a second image corresponding to the second user interface at a position corresponding to the second communication terminal.

8. The apparatus according to claim 2, wherein said detector detects positions of a first communication terminal and a second communication terminal,
said controller projects a first user interface corresponding to the first communication terminal, and projects a second user interface corresponding to the second communication terminal, and
said controller projects a first image corresponding to the first user interface on the first communication terminal, and projects a second image corresponding to the second user interface on the second communication terminal.

9. The apparatus according to claim 7, wherein the first image and the second image are images having different colors, patterns, luminance values, or transparencies.

10. The apparatus according to claim 8, wherein the first image and the second image are images having different colors, patterns, luminance values, or transparencies.

11. A display apparatus for displaying an image on a display surface, comprising:
a display unit adapted to display an image on the display surface;
a communication unit adapted to communicate with a communication terminal;
a detector adapted to detect a position of the communication terminal; and
a controller adapted to set a plurality of specific areas on the image displayed on the display surface, and to execute different processes when the position of the communication terminal detected by said detector corresponds to different specific areas.

12. The apparatus according to claim 11, wherein said controller executes, as the process, one of a process for recording data received from the communication terminal, a process for displaying image data received from the communication terminal, a process for printing image data received from the communication terminal, and a process for transmitting data recorded in said display apparatus to the communication terminal.

13. The apparatus according to claim 11, wherein said controller executes, as the process, a process for transmitting, to the communication terminal via said communication unit, one of: an instruction to transmit all data held by the communication terminal, an instruction to transmit image data which is being displayed by the communication terminal, and an instruction to transmit image data which is being captured by the communication terminal.

14. The apparatus according to claim 11, wherein said controller executes different processes according to a status of the communication terminal when the position of the communication terminal detected by said detector corresponds to the same specific area.

15. A display apparatus for displaying an image on a display surface, comprising:
a display unit adapted to display an image on the display surface;
a communication unit adapted to communicate with a communication terminal;
a detector adapted to detect a position of the communication terminal; and
a controller adapted to execute different processes according to a status of the communication terminal when the position of the communication terminal detected by said detector falls within a range in which the image is displayed.

16. The apparatus according to claim 15, wherein said controller executes, as the process, one of a process for recording a plurality of data received from the communication terminal, a process for recording single image data received from the communication terminal, a process for displaying a plurality of data received from the communication terminal, a process for displaying single image data received from the communication terminal, a process for transmitting image data recorded in said display apparatus to the communication terminal, and a process for printing image data received from the communication terminal.

17. The apparatus according to claim 15, wherein said controller executes, as the process, a process for transmitting one of an instruction to transmit all data held by the communication terminal, an instruction to transmit image data which is being displayed by the communication terminal, and an instruction to transmit image data which is being captured by the communication terminal, to the communication terminal via said communication unit.

18. A display apparatus for displaying an image on a display surface, comprising:
a display unit adapted to display an image on the display surface;
a communication unit adapted to communicate with a communication terminal;
a detector adapted to detect a position of the communication terminal; and
a controller adapted to allow said communication unit to make a data communication with the communication terminal in response to that the position of the communication terminal detected by said detector remains unchanged for not less than a predetermined time period within a range in which the image is displayed by said display unit.

19. The apparatus according to claim 18, wherein said controller controls said display unit to display a user interface corresponding to the communication terminal in response to that the position of the communication terminal remains unchanged for not less than the predetermined time period within the range in which the image is displayed by said display unit.

20. The apparatus according to claim 18, wherein said detector detects the position of the communication terminal based on signals which are output from the communication terminal and are received by not less than three communication devices.

21. The apparatus according to claim 19, wherein said controller controls said display unit to display an image corresponding to the user interface at the detected position of the communication terminal.

22. The apparatus according to claim 19, wherein said detector detects the positions of a first communication terminal and a second communication terminal,
said controller displays a first user interface corresponding to the first communication terminal, and displays a second user interface corresponding to the second communication terminal, and
said controller displays a first image corresponding to the first user interface at the detected position of the first communication terminal, and displays a second image corresponding to the second user interface at a position corresponding to the second communication terminal.

23. A display apparatus for displaying an image on a display surface, comprising:
a display unit adapted to display an image on the display surface;
a communication unit adapted to communicate with a communication terminal;
a detector adapted to detect a position of the communication terminal; and
a controller adapted to execute different processes according to a type of the communication terminal when the position of the communication terminal detected by said detector falls within a range in which the image is displayed.

24. The apparatus according to claim 23, wherein said controller executes, as the process, one of: a process for recording a plurality of data received from the communication terminal, a process for recording single image data received from the communication terminal, a process for displaying a plurality of data received from the communication terminal, a process for displaying single image data received from the communication terminal, a process for transmitting image data recorded in said display apparatus to the communication terminal, and a process for printing image data received from the communication terminal.

25. The apparatus according to claim 23, wherein said controller executes, as the process, a process for transmitting, to the communication terminal via said communication unit, one of: an instruction to transmit all data held by the communication terminal, an instruction to transmit image data which is being displayed by the communication terminal, and an instruction to transmit image data which is being captured by the communication terminal.

26. An information processing apparatus comprising:
an output unit adapted to transmit an image to a display apparatus;
a communication unit adapted to communicate with a communication terminal;
a detector adapted to detect a position of the communication terminal within a range in which an image is displayed by the display apparatus; and
a controller adapted to allow said communication unit to make a data communication with the communication terminal in response to that the position of the communication terminal detected by said detector remains unchanged for not less than a predetermined time period within a range in which the image is displayed by the display apparatus.

27. The apparatus according to claim 26, wherein said controller controls said output unit to output an image including a user interface corresponding to the communication terminal to the display apparatus in response to that the position of the communication terminal remains unchanged for not less than the predetermined time period within the range in which the image is displayed by the display apparatus.

28. The apparatus according to claim 26, wherein said detector detects the position of the communication terminal based on signals which are output from the communication terminal and are received by not less than three communication devices.

29. The apparatus according to claim 27, wherein said controller controls said output unit to output, to the display apparatus, an image including an image corresponding to the user interface at the detected position of the communication terminal.

30. The apparatus according to claim 27, wherein said detector detects positions of a first communication terminal and a second communication terminal, and
said controller controls said output unit to output, to the display apparatus, an image which includes a first user interface image corresponding to the first communication terminal and a second user interface image corresponding to the second communication terminal, and in which a first image corresponding to the first user interface is located at a position corresponding to the detected position of the first communication terminal and a second image corresponding to the second user interface is located at a position corresponding to the second communication terminal.

31. The apparatus according to claim 30, wherein the first image and the second image are images having different colors, patterns, luminance values, or transparencies.

32. A projection system including a communication terminal and a projection apparatus,
said communication terminal comprising:
a first communication unit adapted to communicate with said projection apparatus, and
said projection apparatus comprising:
a projection unit adapted to project an image on a display surface;
a second communication unit adapted to communicate with said communication terminal;
a detector adapted to detect a position of said communication terminal; and
a controller adapted to allow said second communication unit to make a data communication with said communication terminal in response to that the position of said communication terminal detected by said detector remains unchanged for not less than a predetermined time period within a range in which the image is projected by said projection unit.

33. A display system including a communication terminal and a display apparatus,
said communication terminal comprising:
a first communication unit adapted to communicate with said display apparatus, and
said display apparatus comprising:
a display unit adapted to display an image on a display surface;
a second communication unit adapted to communicate with said communication terminal;
a detector adapted to detect a position of said communication terminal; and
a controller adapted to set a plurality of specific areas on the image displayed on the display surface, and to execute different processes when the position of the communication terminal detected by said detector corresponds to different specific areas.

34. A display system including a communication terminal and a display apparatus,
said communication terminal comprising:
a first communication unit adapted to communicate with said display apparatus, and
said display apparatus comprising:
a display unit adapted to display an image on a display surface;
a second communication unit adapted to communicate with said communication terminal;
a detector adapted to detect a position of said communication terminal; and
a controller adapted to execute different processes according to a status of said communication terminal when the position of said communication terminal detected by said detector falls within a range in which the image is displayed.

35. A display system including a communication terminal and a display apparatus,
said communication terminal comprising:
a first communication unit adapted to communicate with said display apparatus, and
said display apparatus comprising:
a display unit adapted to display an image on a display surface;
a second communication unit adapted to communicate with said communication terminal;
a detector adapted to detect a position of said communication terminal; and
a controller adapted to execute different processes according to a type of said communication terminal when the position of said communication terminal detected by said detector falls within a range in which the image is displayed.
